(19) United States
(12) Patent Application Publication
(10) Pub. No.: US 2026/0206026 A1
(43) Pub. Date: Jul. 16, 2026

(54) TECHNIQUES FOR INDICATING SKIPPING CONFIGURED GRANT OCCASIONS FOR PHYSICAL UPLINK SHARED CHANNEL (PUSCH)

(71) Applicant: QUALCOMM Incorporated, San Diego, CA (US)

(72) Inventors: Fang YUAN, Beijing (CN); Iyab Issam SAKHNINI, San Diego, CA (US); Yan ZHOU, San Diego, CA (US)

(21) Appl. No.: 19/136,107

(22) PCT Filed: Feb. 24, 2023
(86) PCT No.: PCT/CN2023/078048

§ 371 Date: Jun. 5, 2025

(51) Int. Cl. H04W 72/21; H04W 72/115

(52) U.S. Cl. CPC H04W 72/21; H04W 72/115

(57) ABSTRACT

Various aspects of the present disclosure generally relate to wireless communication. In some aspects, a user equipment (UE) may transmit, in a first physical uplink shared channel (PUSCH) occasion, a first PUSCH communication including an indication associated with at least one skipped configured grant (CG) occasion. The UE may receive a scheduling communication that indicates a second PUSCH occasion for a re-transmission of the first PUSCH communication. The UE may transmit, in the second PUSCH occasion, a second PUSCH communication, the second PUSCH communication including a re-transmission of the first PUSCH communication and the indication associated with the at least one skipped CG occasion. Numerous other aspects are described.

### FIELD OF THE DISCLOSURE

Aspects of the present disclosure generally relate to wireless communication and to techniques and apparatuses for indicating skipping configured grant occasions for physical uplink shared channel (PUSCH).

### DESCRIPTION OF RELATED ART

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth, transmit power, etc.). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

These multiple access technologies have been adopted in various telecommunication standards to provide a common protocol that enables different UEs to communicate on a municipal, national, regional, or global level. New Radio (NR), which also may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency-division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation.

### SUMMARY

Some aspects described herein relate to a method of wireless communication performed by a user equipment (UE). The method may include transmitting, in a first physical uplink shared channel (PUSCH) occasion, a first PUSCH communication including an indication associated with at least one skipped configured grant (CG) occasion. The method may include receiving a scheduling communication that indicates a second PUSCH occasion for a re-transmission of the first PUSCH communication. The method may include transmitting, in the second PUSCH occasion, a second PUSCH communication, the second PUSCH communication including a re-transmission of the first PUSCH communication and the indication associated with the at least one skipped CG occasion.

Some aspects described herein relate to a method of wireless communication performed by a network node. The method may include receiving, in a first PUSCH occasion, a first PUSCH communication including an indication associated with at least one skipped CG occasion. The method may include transmitting a scheduling communication that indicates a second PUSCH occasion for a re-transmission of the first PUSCH communication. The method may include receiving, in the second PUSCH occasion, a second PUSCH communication, the second PUSCH communication including a re-transmission of the first PUSCH communication and the indication associated with the at least one skipped CG occasion.

Some aspects described herein relate to a method of wireless communication performed by a UE. The method may include transmitting, in a PUSCH occasion, a PUSCH communication including an indication associated with at least one skipped CG occasion. The method may include receiving a confirmation communication that indicates reception, by a network node, of the indication associated with the at least one skipped CG occasion.

Some aspects described herein relate to a method of wireless communication performed by a network node. The method may include receiving, in a PUSCH occasion, a PUSCH communication including an indication associated with at least one skipped CG occasion. The method may include transmitting a confirmation communication that indicates reception, by a network node, of the indication associated with the at least one skipped CG occasion.

Some aspects described herein relate to a method of wireless communication performed by a UE. The method may include transmitting, in a PUSCH occasion, a first PUSCH communication including an indication associated with at least one skipped CG occasion. The method may include transmitting, in an unskipped CG occasion of the at least one CG occasion, an uplink communication including uplink control information (UCI) multiplexed with a second PUSCH communication.

Some aspects described herein relate to a method of wireless communication performed by a network node. The method may include receiving, in a PUSCH occasion, a first PUSCH communication including an indication associated with at least one skipped CG occasion. The method may include receiving, in an unskipped CG occasion of the at least one CG occasion, an uplink communication comprising UCI multiplexed with a second PUSCH communication.

Some aspects described herein relate to a UE for wireless communication. The user equipment may include a memory and one or more processors coupled to the memory. The one or more processors may be configured to transmit, in a first PUSCH occasion, a first PUSCH communication including an indication associated with at least one skipped CG occasion. The one or more processors may be configured to receive a scheduling communication that indicates a second PUSCH occasion for a re-transmission of the first PUSCH communication. The one or more processors may be configured to transmit, in the second PUSCH occasion, a second PUSCH communication, the second PUSCH communication including a re-transmission of the first PUSCH communication and the indication associated with the at least one skipped CG occasion.

Some aspects described herein relate to a network node for wireless communication. The network node may include a memory and one or more processors coupled to the memory. The one or more processors may be configured to receive, in a first PUSCH occasion, a first PUSCH communication including an indication associated with at least one skipped CG occasion. The one or more processors may be configured to transmit a scheduling communication that indicates a second PUSCH occasion for a re-transmission of the first PUSCH communication. The one or more processors may be configured to receive, in the second PUSCH occasion, a second PUSCH communication, the second PUSCH communication including a re-transmission of the first PUSCH communication and the indication associated with the at least one skipped CG occasion.

Some aspects described herein relate to a UE for wireless communication. The user equipment may include a memory and one or more processors coupled to the memory. The one or more processors may be configured to transmit, in a PUSCH occasion, a PUSCH communication including an indication associated with at least one skipped CG occasion. The one or more processors may be configured to receive a confirmation communication that indicates reception of the indication associated with the at least one skipped CG occasion.

Some aspects described herein relate to a network node for wireless communication. The network node may include a memory and one or more processors coupled to the memory. The one or more processors may be configured to receive, in a PUSCH occasion, a PUSCH communication including an indication associated with at least one skipped CG occasion. The one or more processors may be configured to transmit a confirmation communication that indicates reception of the indication associated with the at least one skipped CG occasion.

Some aspects described herein relate to a UE for wireless communication. The user equipment may include a memory and one or more processors coupled to the memory. The one or more processors may be configured to transmit, in a PUSCH occasion, a first PUSCH communication including an indication associated with at least one skipped CG occasion. The one or more processors may be configured to transmit, in an unskipped CG occasion of the at least one CG occasion, an uplink communication including UCI multiplexed with a second PUSCH communication.

Some aspects described herein relate to a network node for wireless communication. The network node may include a memory and one or more processors coupled to the memory. The one or more processors may be configured to receive, in a PUSCH occasion, a first PUSCH communication including an indication associated with at least one skipped CG occasion. The one or more processors may be configured to receive, in an unskipped CG occasion of the at least one CG occasion, an uplink communication comprising UCI multiplexed with a second PUSCH communication.

Some aspects described herein relate to a non-transitory computer-readable medium that stores a set of instructions for wireless communication by a UE. The set of instructions, when executed by one or more processors of the UE, may cause the UE to transmit, in a first PUSCH occasion, a first PUSCH communication including an indication associated with at least one skipped CG occasion. The set of instructions, when executed by one or more processors of the UE, may cause the UE to receive a scheduling communication that indicates a second PUSCH occasion for a re-transmission of the first PUSCH communication. The set of instructions, when executed by one or more processors of the UE, may cause the UE to transmit, in the second PUSCH occasion, a second PUSCH communication, the second PUSCH communication including a re-transmission of the first PUSCH communication and the indication associated with the at least one skipped CG occasion.

Some aspects described herein relate to a non-transitory computer-readable medium that stores a set of instructions for wireless communication by a network node. The set of instructions, when executed by one or more processors of the network node, may cause the network node to receive, in a first PUSCH occasion, a first PUSCH communication including an indication associated with at least one skipped CG occasion. The set of instructions, when executed by one or more processors of the network node, may cause the network node to transmit a scheduling communication that indicates a second PUSCH occasion for a re-transmission of the first PUSCH communication. The set of instructions, when executed by one or more processors of the network node, may cause the network node to receive, in the second PUSCH occasion, a second PUSCH communication, the second PUSCH communication including a re-transmission of the first PUSCH communication and the indication associated with the at least one skipped CG occasion.

Some aspects described herein relate to a non-transitory computer-readable medium that stores a set of instructions for wireless communication by an UE. The set of instructions, when executed by one or more processors of the UE, may cause the UE to transmit, in a PUSCH occasion, a PUSCH communication including an indication associated with at least one skipped CG occasion. The set of instructions, when executed by one or more processors of the UE, may cause the UE to receive a confirmation communication that indicates reception of the indication associated with the at least one skipped CG occasion.

Some aspects described herein relate to a non-transitory computer-readable medium that stores a set of instructions for wireless communication by a network node. The set of instructions, when executed by one or more processors of the network node, may cause the network node to receive, in a PUSCH occasion, a PUSCH communication including an indication associated with at least one skipped CG occasion. The set of instructions, when executed by one or more processors of the network node, may cause the network node to transmit a confirmation communication that indicates reception of the indication associated with the at least one skipped CG occasion.

Some aspects described herein relate to a non-transitory computer-readable medium that stores a set of instructions for wireless communication by an UE. The set of instructions, when executed by one or more processors of the UE, may cause the UE to transmit, in a PUSCH occasion, a first PUSCH communication including an indication associated with at least one skipped CG occasion. The set of instructions, when executed by one or more processors of the UE, may cause the UE to transmit, in an unskipped CG occasion of the at least one CG occasion, an uplink communication including UCI multiplexed with a second PUSCH communication.

Some aspects described herein relate to a non-transitory computer-readable medium that stores a set of instructions for wireless communication by a network node. The set of instructions, when executed by one or more processors of the network node, may cause the network node to receive, in a PUSCH occasion, a first PUSCH communication including an indication associated with at least one skipped CG occasion. The set of instructions, when executed by one or more processors of the network node, may cause the network node to receive, in an unskipped CG occasion of the at least one CG occasion, an uplink communication comprising UCI multiplexed with a second PUSCH communication.

Some aspects described herein relate to an apparatus for wireless communication. The apparatus may include means for transmitting, in a first PUSCH occasion, a first PUSCH communication including an indication associated with at least one skipped CG occasion. The apparatus may include means for receiving a scheduling communication that indicates a second PUSCH occasion for a re-transmission of the first PUSCH communication. The apparatus may include means for transmitting, in the second PUSCH occasion, a second PUSCH communication, the second PUSCH communication including a re-transmission of the first PUSCH communication and the indication associated with the at least one skipped CG occasion.

Some aspects described herein relate to an apparatus for wireless communication. The apparatus may include means for receiving, in a first PUSCH occasion, a first PUSCH communication including an indication associated with at least one skipped CG occasion. The apparatus may include means for transmitting a scheduling communication that indicates a second PUSCH occasion for a re-transmission of the first PUSCH communication. The apparatus may include means for receiving, in the second PUSCH occasion, a second PUSCH communication, the second PUSCH communication including a re-transmission of the first PUSCH communication and the indication associated with the at least one skipped CG occasion.

Some aspects described herein relate to an apparatus for wireless communication. The apparatus may include means for transmitting, in a PUSCH occasion, a PUSCH communication including an indication associated with at least one skipped CG occasion. The apparatus may include means for receiving a confirmation communication that indicates reception of the indication associated with the at least one skipped CG occasion.

Some aspects described herein relate to an apparatus for wireless communication. The apparatus may include means for receiving, in a PUSCH occasion, a PUSCH communication including an indication associated with at least one skipped CG occasion. The apparatus may include means for transmitting a confirmation communication that indicates reception of the indication associated with the at least one skipped CG occasion.

Some aspects described herein relate to an apparatus for wireless communication. The apparatus may include means for transmitting, in a PUSCH occasion, a first PUSCH communication including an indication associated with at least one skipped CG occasion. The apparatus may include means for transmitting, in an unskipped CG occasion of the at least one CG occasion, an uplink communication including UCI multiplexed with a second PUSCH communication.

Some aspects described herein relate to an apparatus for wireless communication. The apparatus may include means for receiving, in a PUSCH occasion, a first PUSCH communication including an indication associated with at least one skipped CG occasion. The apparatus may include means for receiving, in an unskipped CG occasion of the at least one CG occasion, an uplink communication comprising UCI multiplexed with a second PUSCH communication.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network.

FIG. 2 is a diagram illustrating an example of a network node in communication with a user equipment (UE) in a wireless network.

FIG. 3 is a diagram illustrating an example disaggregated base station architecture, in accordance with the present disclosure.

FIG. 4 is a diagram illustrating an example of uplink configured grant (CG) communication, in accordance with the present disclosure.

FIG. 5 is a diagram illustrating an example associated with skipping CG physical uplink shared channel (PUSCH) occasions, in accordance with the present disclosure.

FIGS. 6A-6C are diagrams illustrating examples associated with techniques for indicating skipping CG occasions for PUSCH, in accordance with the present disclosure.

FIG. 7 is a diagram illustrating an example process performed, for example, by a UE, in accordance with the present disclosure.

FIG. 8 is a diagram illustrating an example process performed, for example, by a network node, in accordance with the present disclosure.

FIG. 9 is a diagram illustrating an example process performed, for example, by a UE, in accordance with the present disclosure.

FIG. 10 is a diagram illustrating an example process performed, for example, by a network node, in accordance with the present disclosure.

FIG. 11 is a diagram illustrating an example process performed, for example, by a UE, in accordance with the present disclosure.

FIG. 12 is a diagram illustrating an example process performed, for example, by a network node, in accordance with the present disclosure.

FIG. 13 is a diagram of an example apparatus for wireless communication, in accordance with the present disclosure.

FIG. 14 is a diagram of an example apparatus for wireless communication, in accordance with the present disclosure.

### DETAILED DESCRIPTION

In some cases, a user equipment (UE) may multiplex uplink control information (UCI) in a configured grant (CG) physical uplink shared channel (PUSCH) occasion. In some cases, the UE may transmit an indication (a “skipping indication”) associated with one or more skipped CG PUCSH occasions. Due to a UCI multiplexing rule, in an example, the UCI may be scheduled to be transmitted in a first CG PUSCH occasion. However, as the UE may skip the first CG PUSCH occasion, the UE may, instead multiplex the UCI in a second CG PUSCH occasion that is not skipped.

However, in some cases, a transmitted skipping indication may be lost and not received by the network node, in which case, the network node would not be aware that the UCI is to be multiplexed in the second CG PUSCH occasion instead of the first CG PUSCH occasion. Accordingly, the UCI also may not be received by the network node. In this way, CG PUSCH occasion skipping can causes misalignment between the UE and the network node for UCI multiplexing, resulting in inefficient and unreliable communications, and thereby negatively impacting network performance.

Some aspects of the techniques and apparatuses described herein provide support for indicating skipping CG occasions for PUSCH. For example, in some aspects, a UE may transmit, in a first PUSCH occasion, a first PUSCH communication including an indication associated with at least one skipped CG occasion. In some aspects, the UE may receive a scheduling communication that indicates a second PUSCH occasion for a re-transmission of the first PUSCH communication and may transmit, in the second PUSCH occasion, a second PUSCH communication, the second PUSCH communication including a re-transmission of the first PUSCH communication and the indication associated with the at least one skipped CG occasion. In this way, the reliability of indicating skipped CG PUSCH occasions may be improved. In some aspects, the UE may receive a confirmation communication that indicates reception, by a network node, of the indication associated with the at least one skipped CG occasion. In this way, reliability of indicating skipped CG PUSCH occasions may be improved. In some aspects, the UE may transmit, in an unskipped CG occasion of the at least one CG occasion, an uplink communication including UCI multiplexed with a second PUSCH communication. In this way, alignment and reliability of UCI multiplexing in CG PUSCH occasions can be improved. Thus, some aspects may facilitate efficient and reliable communications, and thereby positively impact network performance.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Aspects and examples generally include a method, apparatus, network node, system, computer program product, non-transitory computer-readable medium, user equipment, base station, wireless communication device, and/or processing system as described or substantially described herein with reference to and as illustrated by the drawings and specification.

This disclosure may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, are better understood from the following description when considered in connection with the accompanying figures. Each of the figures is provided for the purposes of illustration and description, and not as a definition of the limits of the claims.

While aspects are described in the present disclosure by illustration to some examples, such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component-based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). Aspects described herein may be practiced in a wide variety of devices, components, systems, distributed arrangements, and/or end-user devices of varying size, shape, and constitution.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

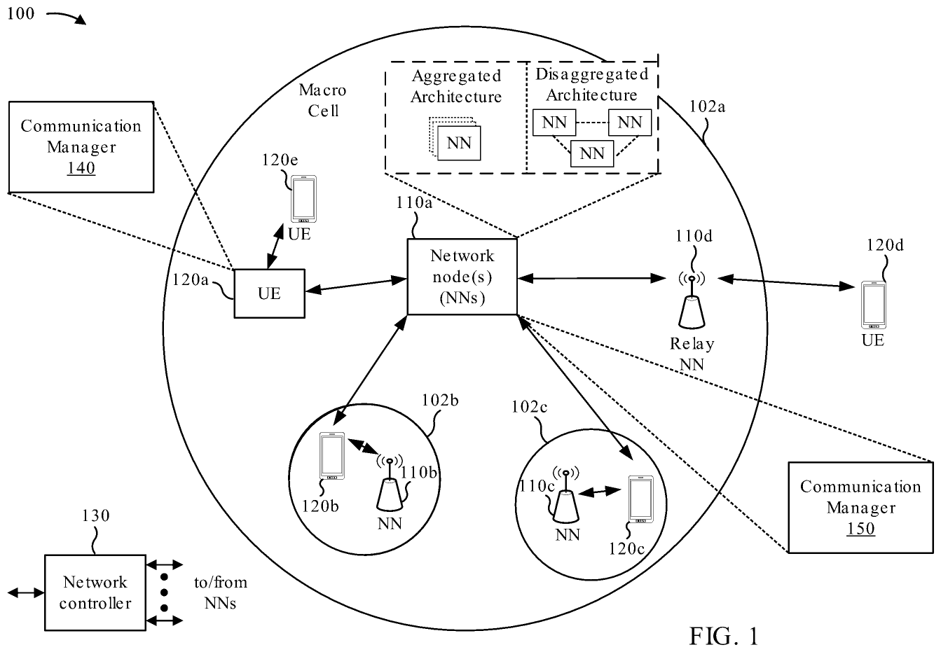

FIG. 1 is a diagram illustrating an example of a wireless network 100. The wireless network 100 may be or may include elements of a 5G (for example, NR) network or a 4G (for example, Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), or other entities. A network node 110 is an example of a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (for example, in 4G), a gNB (for example, in 5G), an access point, or a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 or a network node subsystem serving this coverage area, depending on the context in which the term is used. A network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (for example, three) cells. In some examples, a cell may not necessarily be stationary, and the geographic area of the cell may move according to the location of a network node 110 that is mobile (for example, a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (for example, a network node 110 or a UE 120) and send a transmission of the data to a downstream node (for example, a UE 120 or a network node 110). A relay station may be a UE 120 that can relay transmissions for other UEs 120. In the example shown in FIG. 1, the network node 110d (for example, a relay network node) may communicate with the network node 110a (for example, a macro network node) and the UE 120d in order to facilitate communication between the network node 110a and the UE 120d. A network node 110 that relays communications may be referred to as a relay station, a relay base station, a relay network node, a relay node, or a relay, among other examples.

The wireless network 100 may be a heterogeneous network that includes network nodes 110 of different types, such as macro network nodes, pico network nodes, femto network nodes, or relay network nodes. These different types of network nodes 110 may have different transmit power levels, different coverage areas, or different impacts on interference in the wireless network 100. For example, macro network nodes may have a high transmit power level (for example, 5 to 40 watts) whereas pico network nodes, femto network nodes, and relay network nodes may have lower transmit power levels (for example, 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, a UE function of a network node, or any other suitable device that is configured to communicate via a wireless or wired medium.

Some UEs 120 may be considered machine-type communication (MTC) or evolved or enhanced machine-type communication (eMTC) UEs. An MTC UE or an eMTC UE may include, for example, a robot, a drone, a remote device, a sensor, a meter, a monitor, or a location tag, that may communicate with a network node, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any number of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120e) may communicate directly using one or more sidelink channels (for example, without using a network node 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the network node 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With these examples in mind, unless specifically stated otherwise, the term “sub-6 GHz,” if used herein, may broadly represent frequencies that may be less than 6 GHz, may be within FR1, or may include mid-band frequencies. Further, unless specifically stated otherwise, the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, a UE (e.g., the UE 120) may include a communication manager 140. As described in more detail elsewhere herein, the communication manager 140 may transmit, in a first physical uplink shared channel (PUSCH) occasion, a first PUSCH communication including an indication associated with at least one skipped configured grant (CG) occasion; receive a scheduling communication that indicates a second PUSCH occasion for a re-transmission of the first PUSCH communication; and transmit, in the second PUSCH occasion, a second PUSCH communication, the second PUSCH communication including a re-transmission of the first PUSCH communication and the indication associated with the at least one skipped CG occasion.

In some aspects, the communication manager 140 may transmit, in a PUSCH occasion, a PUSCH communication including an indication associated with at least one skipped CG occasion; and receive a confirmation communication that indicates reception of the indication associated with the at least one skipped CG occasion.

In some aspects, the communication manager 140 may transmit, in a PUSCH occasion, a first PUSCH communication including an indication associated with at least one skipped CG occasion; and transmit, in an unskipped CG occasion of the at least one CG occasion, an uplink communication including UCI multiplexed with a second PUSCH communication. Additionally, or alternatively, the communication manager 140 may perform one or more other operations described herein.

In some aspects, a network node (e.g., the network node 110) may include a communication manager 150. As described in more detail elsewhere herein, the communication manager 150 may receive, in a first PUSCH occasion, a first PUSCH communication including an indication associated with at least one skipped CG occasion; transmit a scheduling communication that indicates a second PUSCH occasion for a re-transmission of the first PUSCH communication; and receive, in the second PUSCH occasion, a second PUSCH communication, the second PUSCH communication including a re-transmission of the first PUSCH communication and the indication associated with the at least one skipped CG occasion.

In some aspects, the communication manager 150 may receive, in a PUSCH occasion, a PUSCH communication including an indication associated with at least one skipped CG occasion; and transmit a confirmation communication that indicates reception of the indication associated with the at least one skipped CG occasion. Additionally, or alternatively, the communication manager 150 may perform one or more other operations described herein.

In some aspects, the communication manager 150 may receive, in a PUSCH occasion, a first PUSCH communication including an indication associated with at least one skipped CG occasion; and receive, in an unskipped CG occasion of the at least one CG occasion, an uplink communication comprising UCI multiplexed with a second PUSCH communication. Additionally, or alternatively, the communication manager 150 may perform one or more other operations described herein.

As indicated above, FIG. 1 is provided as an example. Other examples may differ from what is described with regard to FIG. 1.

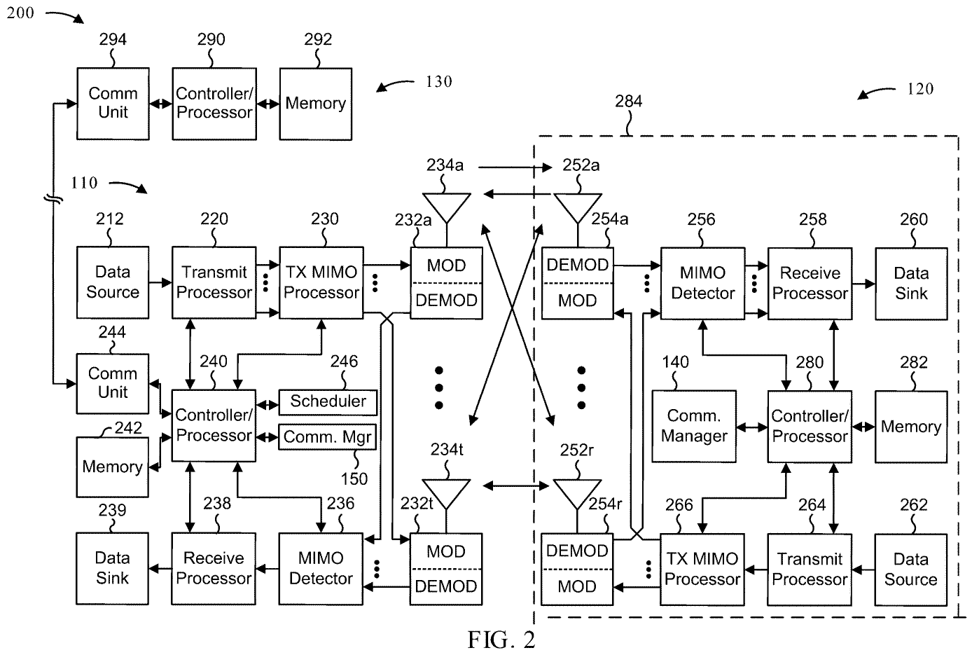

FIG. 2 is a diagram illustrating an example 200 of a network node 110 in communication with a UE 120 in a wireless network 100. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 using one or more channel quality indicators (CQIs) received from that UE 120. The network node 110 may process (for example, encode and modulate) the data for the UE 120 using the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the network node 110 or other network nodes 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

Each of the antenna elements may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, or other types of antennas arranged in a linear pattern, a two-dimensional pattern, or another pattern. A spacing between antenna elements may be such that signals with a desired wavelength transmitted separately by the antenna elements may interact or interfere (e.g., to form a desired beam). For example, given an expected range of wavelengths or frequencies, the spacing may provide a quarter wavelength, half wavelength, or other fraction of a wavelength of spacing between neighboring antenna elements to allow for interaction or interference of signals transmitted by the separate antenna elements within that expected range.

Antenna elements and/or sub-elements may be used to generate beams. “Beam” may refer to a directional transmission such as a wireless signal that is transmitted in a direction of a receiving device. A beam may include a directional signal, a direction associated with a signal, a set of directional resources associated with a signal (e.g., angle of arrival, horizontal direction, vertical direction), and/or a set of parameters that indicate one or more aspects of a directional signal, a direction associated with a signal, and/or a set of directional resources associated with a signal.

As indicated above, antenna elements and/or sub-elements may be used to generate beams. For example, antenna elements may be individually selected or deselected for transmission of a signal (or signals) by controlling an amplitude of one or more corresponding amplifiers. Beamforming includes generation of a beam using multiple signals on different antenna elements, where one or more, or all, of the multiple signals are shifted in phase relative to each other. The formed beam may carry physical or higher layer reference signals or information. As each signal of the multiple signals is radiated from a respective antenna element, the radiated signals interact, interfere (constructive and destructive interference), and amplify each other to form a resulting beam. The shape (such as the amplitude, width, and/or presence of side lobes) and the direction (such as an angle of the beam relative to a surface of an antenna array) can be dynamically controlled by modifying the phase shifts or phase offsets of the multiple signals relative to each other.

Beamforming may be used for communications between a UE and a network node, such as for millimeter wave communications and/or the like. In such a case, the network node may provide the UE with a configuration of transmission configuration indicator (TCI) states that respectively indicate beams that may be used by the UE, such as for receiving a physical downlink shared channel (PDSCH). A TCI state indicates a spatial parameter for a communication. For example, a TCI state for a communication may identify a source signal (such as a synchronization signal block, a channel state information reference signal, or the like) and a spatial parameter to be derived from the source signal for the purpose of transmitting or receiving the communication. For example, the TCI state may indicate a quasi-co-location (QCL) type. A QCL type may indicate one or more spatial parameters to be derived from the source signal. The source signal may be referred to as a QCL source. The network node may indicate an activated TCI state to the UE, which the UE may use to select a beam for receiving the PDSCH.

A beam indication may be, or include, a TCI state information element, a beam identifier (ID), spatial relation information, a TCI state ID, a closed loop index, a panel ID, a TRP ID, and/or a sounding reference signal (SRS) set ID, among other examples. A TCI state information element (referred to as a TCI state herein) may indicate information associated with a beam such as a downlink beam. For example, the TCI state information element may indicate a TCI state identification (e.g., a tci-StateID), a QCL type (e.g., a qcl-Type1, qcl-Type2, qcl-TypeA, qcl-TypeB, qcl-TypeC, qcl-TypeD, and/or the like), a cell identification (e.g., a ServCellIndex), a bandwidth part identification (bwp-Id), a reference signal identification such as a CSI-RS (e.g., an NZP-CSI-RS-ResourceId, an SSB-Index, and/or the like), and/or the like. Spatial relation information may similarly indicate information associated with an uplink beam.

The beam indication may be a joint or separate downlink (DL)/uplink (UL) beam indication in a unified TCI framework. In some cases, the network may support layer 1 (L1)-based beam indication using at least UE-specific (unicast) downlink control information (DCI) to indicate joint or separate DL/UL beam indications from active TCI states. In some cases, existing DCI formats 1_1 and/or 1_2 may be reused for beam indication. The network may include a support mechanism for a UE to acknowledge successful decoding of a beam indication. For example, the acknowledgment/negative acknowledgment (ACK/NACK) of the PDSCH scheduled by the DCI carrying the beam indication may be also used as an ACK for the DCI.

Beam indications may be provided for carrier aggregation (CA) scenarios. In a unified TCI framework, information the network may support common TCI state ID update and activation to provide common QCL and/or common UL transmission spatial filter or filters across a set of configured component carriers (CCs). This type of beam indication may apply to intra-band CA, as well as to joint DL/UL and separate DL/UL beam indications. The common TCI state ID may imply that one reference signal (RS) determined according to the TCI state(s) indicated by a common TCI state ID is used to provide QCL Type-D indication and to determine UL transmission spatial filters across the set of configured CCs.

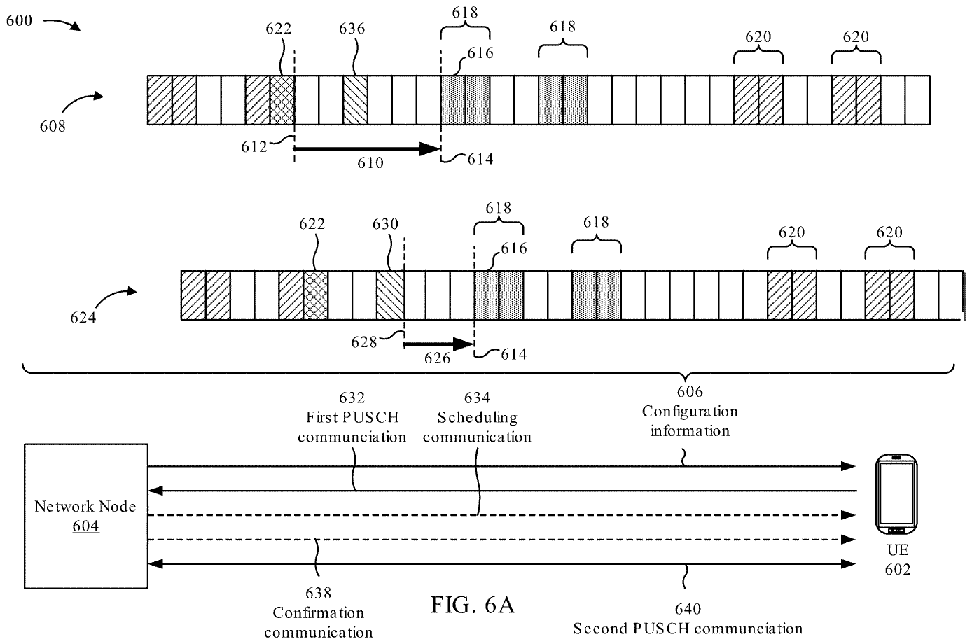

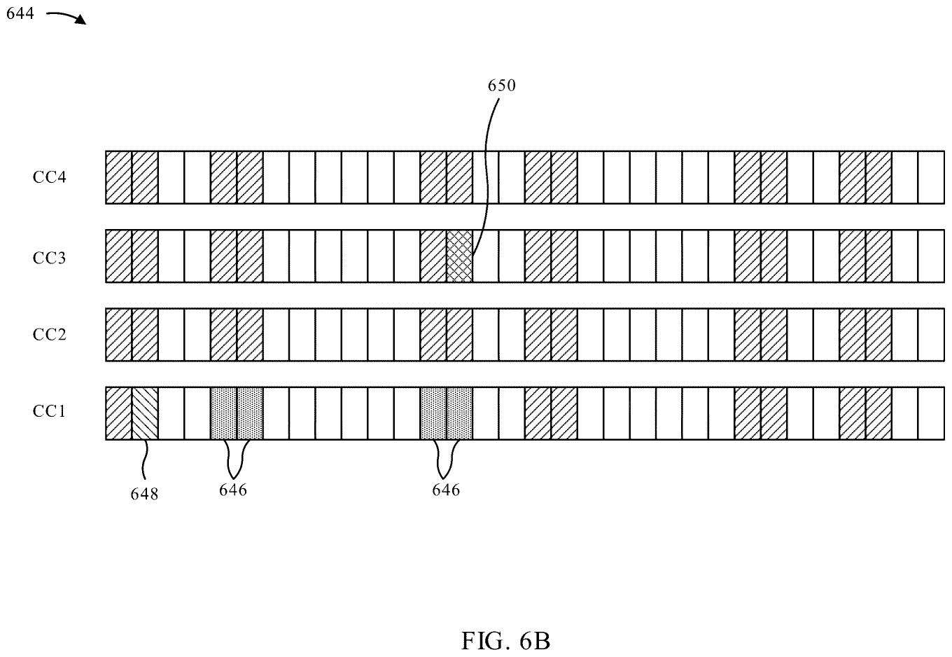

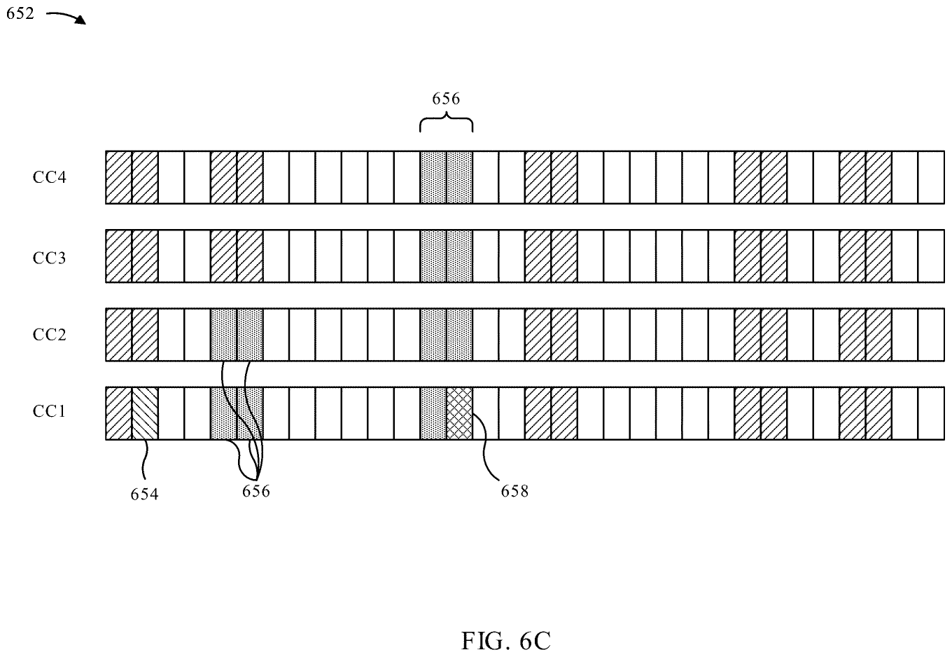

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the processes described herein (e.g., with reference to FIGS. 6A-14).

At the network node 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the processes described herein (e.g., with reference to FIGS. 6A-14).

In some aspects, the controller/processor 280 may be a component of a processing system. A processing system may generally be a system or a series of machines or components that receives inputs and processes the inputs to produce a set of outputs (which may be passed to other systems or components of, for example, the UE 120). For example, a processing system of the UE 120 may be a system that includes the various other components or subcomponents of the UE 120.

The processing system of the UE 120 may interface with one or more other components of the UE 120, may process information received from one or more other components (such as inputs or signals), or may output information to one or more other components. For example, a chip or modem of the UE 120 may include a processing system, a first interface to receive or obtain information, and a second interface to output, transmit, or provide information. In some examples, the first interface may be an interface between the processing system of the chip or modem and a receiver, such that the UE 120 may receive information or signal inputs, and the information may be passed to the processing system. In some examples, the second interface may be an interface between the processing system of the chip or modem and a transmitter, such that the UE 120 may transmit information output from the chip or modem. A person having ordinary skill in the art will readily recognize that the second interface also may obtain or receive information or signal inputs, and the first interface also may output, transmit, or provide information.

In some aspects, the controller/processor 240 may be a component of a processing system. A processing system may generally be a system or a series of machines or components that receives inputs and processes the inputs to produce a set of outputs (which may be passed to other systems or components of, for example, the network node 110). For example, a processing system of the network node 110 may be a system that includes the various other components or subcomponents of the network node 110.

The processing system of the network node 110 may interface with one or more other components of the network node 110, may process information received from one or more other components (such as inputs or signals), or may output information to one or more other components. For example, a chip or modem of the network node 110 may include a processing system, a first interface to receive or obtain information, and a second interface to output, transmit, or provide information. In some examples, the first interface may be an interface between the processing system of the chip or modem and a receiver, such that the network node 110 may receive information or signal inputs, and the information may be passed to the processing system. In some examples, the second interface may be an interface between the processing system of the chip or modem and a transmitter, such that the network node 110 may transmit information output from the chip or modem. A person having ordinary skill in the art will readily recognize that the second interface also may obtain or receive information or signal inputs, and the first interface also may output, transmit, or provide information.

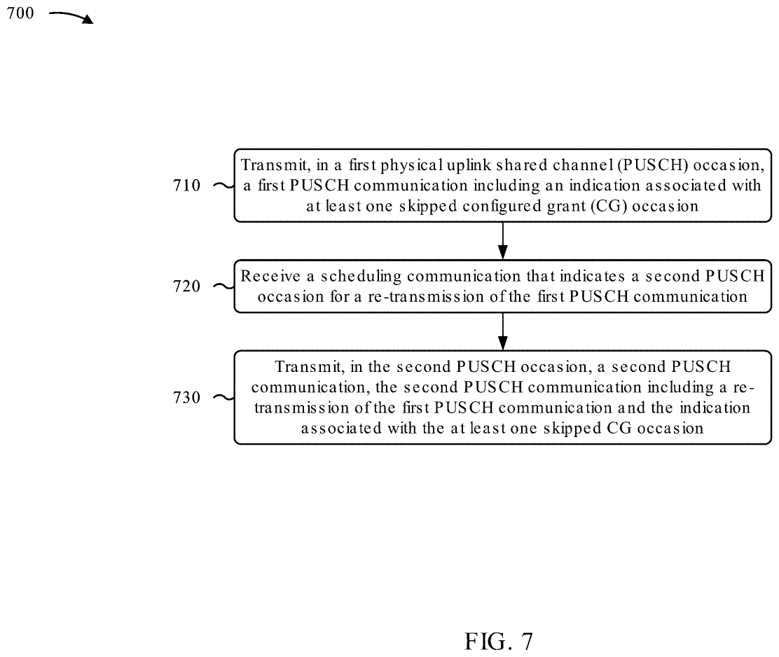

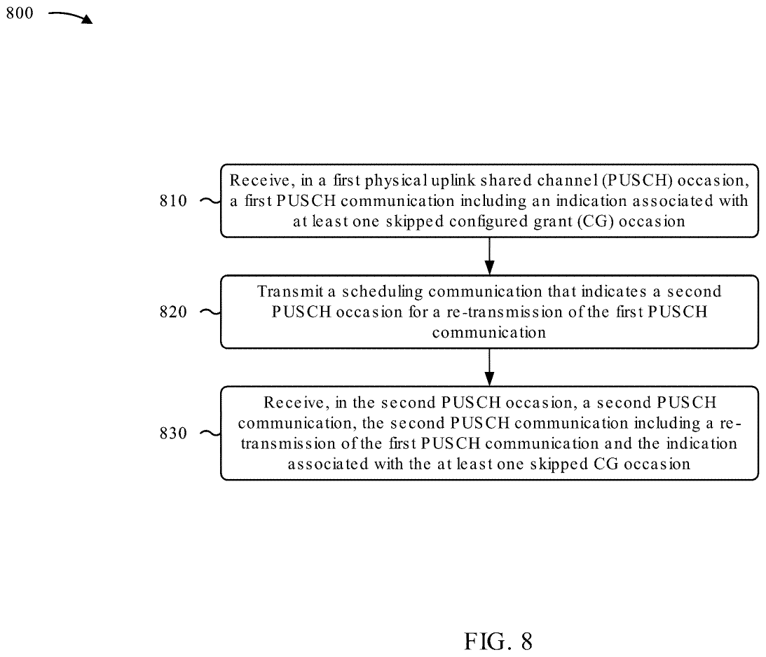

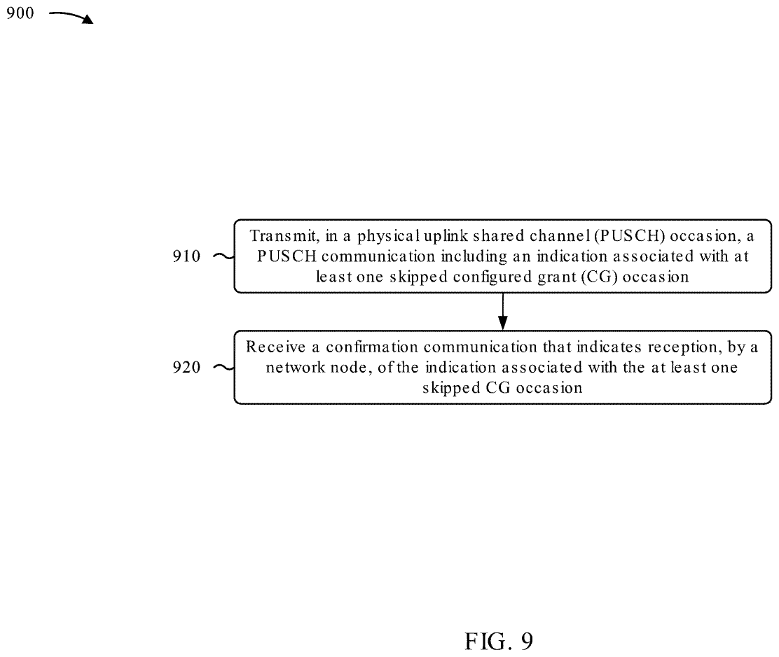

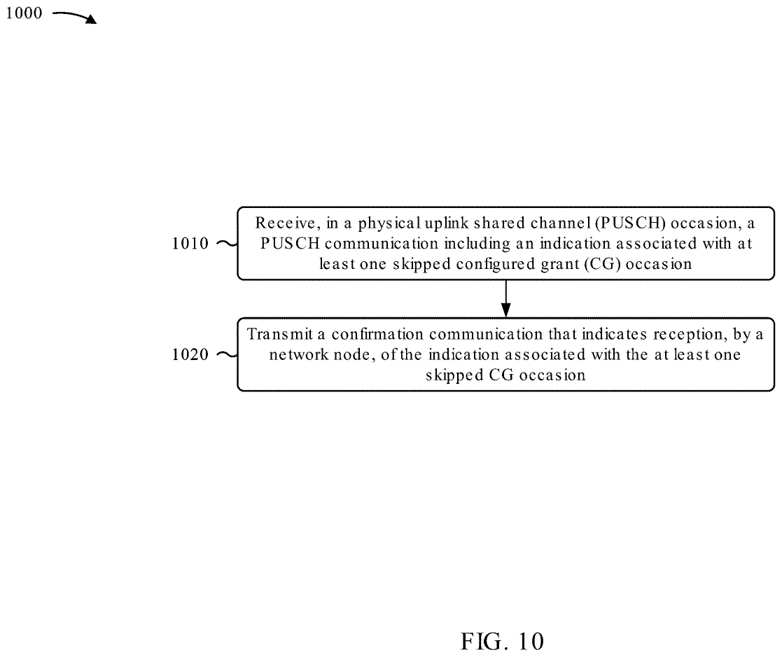

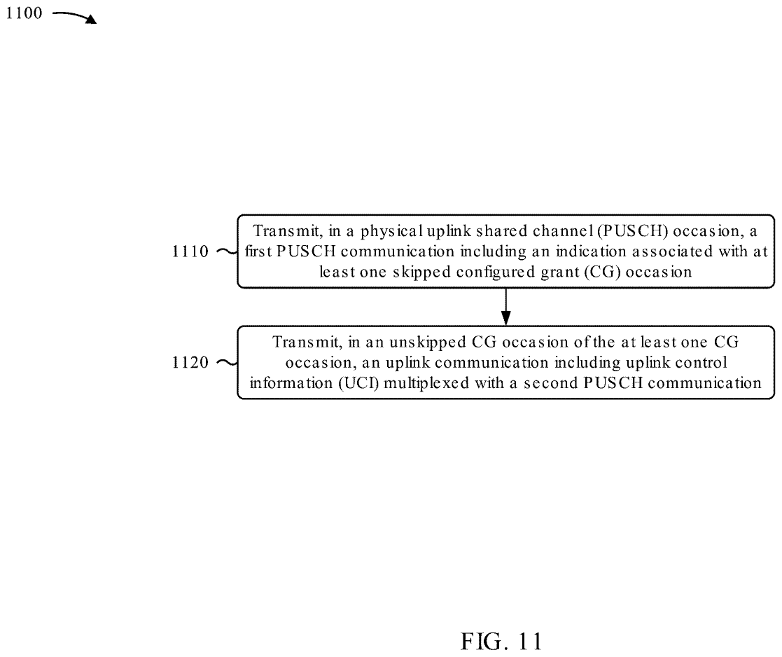

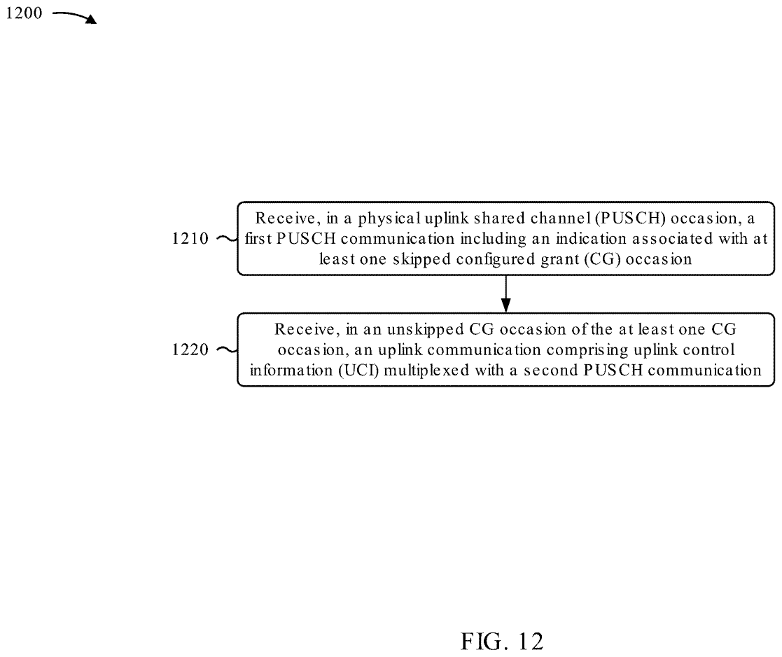

The controller/processor 240 of the network node 110, the controller/processor 280 of the UE 120, or any other component(s) of FIG. 2 may perform one or more techniques associated with indicating skipping configured grant occasions for PUSCH, as described in more detail elsewhere herein. For example, the controller/processor 240 of the network node 110, the controller/processor 280 of the UE 120, or any other component(s) (or combinations of components) of FIG. 2 may perform or direct operations of, for example, process 700 of FIG. 7, process 800 of FIG. 8, process 900 of FIG. 9, process 1000 of FIG. 10, process 1100 of FIG. 11, process 1200 of FIG. 12, and/or other processes as described herein. The memory 242 and the memory 282 may store data and program codes for the network node 110 and the UE 120, respectively. In some examples, the memory 242 and the memory 282 may include a non-transitory computer-readable medium storing one or more instructions (for example, code or program code) for wireless communication. For example, the one or more instructions, when executed (for example, directly, or after compiling, converting, or interpreting) by one or more processors of the network node 110 or the UE 120, may cause the one or more processors, the UE 120, or the network node 110 to perform or direct operations of, for example, process 700 of FIG. 7, process 800 of FIG. 8, process 900 of FIG. 9, process 1000 of FIG. 10, process 1100 of FIG. 11, process 1200 of FIG. 12, and/or other processes as described herein. In some examples, executing instructions may include running the instructions, converting the instructions, compiling the instructions, and/or interpreting the instructions, among other examples.

In some aspects, a UE (e.g., the UE 120) includes means for transmitting, in a first PUSCH occasion, a first PUSCH communication including an indication associated with at least one skipped CG) occasion; means for receiving a scheduling communication that indicates a second PUSCH occasion for a re-transmission of the first PUSCH communication; and/or means for transmitting, in the second PUSCH occasion, a second PUSCH communication, the second PUSCH communication including a re-transmission of the first PUSCH communication and the indication associated with the at least one skipped CG occasion.

In some aspects, the UE includes means for transmitting, in a PUSCH occasion, a PUSCH communication including an indication associated with at least one skipped CG occasion; and/or means for receiving a confirmation communication that indicates reception, by a network node, of the indication associated with the at least one skipped CG occasion.

In some aspects, the UE includes means for transmitting, in a PUSCH occasion, a first PUSCH communication including an indication associated with at least one skipped CG occasion; and/or means for transmitting, in an unskipped CG occasion of the at least one CG occasion, an uplink communication including uplink control information (UCI) multiplexed with a second PUSCH communication. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node (e.g., the network node 110) includes means for receiving, in a first PUSCH occasion, a first PUSCH communication including an indication associated with at least one skipped CG occasion; means for transmitting a scheduling communication that indicates a second PUSCH occasion for a re-transmission of the first PUSCH communication; and/or means for receiving, in the second PUSCH occasion, a second PUSCH communication, the second PUSCH communication including a re-transmission of the first PUSCH communication and the indication associated with the at least one skipped CG occasion.

In some aspects, the network node includes means for receiving, in a PUSCH occasion, a PUSCH communication including an indication associated with at least one skipped CG occasion; and/or means for transmitting a confirmation communication that indicates reception, by a network node, of the indication associated with the at least one skipped CG occasion.

In some aspects, the network node includes means for receiving, in a PUSCH occasion, a first PUSCH communication including an indication associated with at least one skipped CG occasion; and/or means for receiving, in an unskipped CG occasion of the at least one CG occasion, an uplink communication comprising uplink control information (UCI) multiplexed with a second PUSCH communication. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (for example, within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

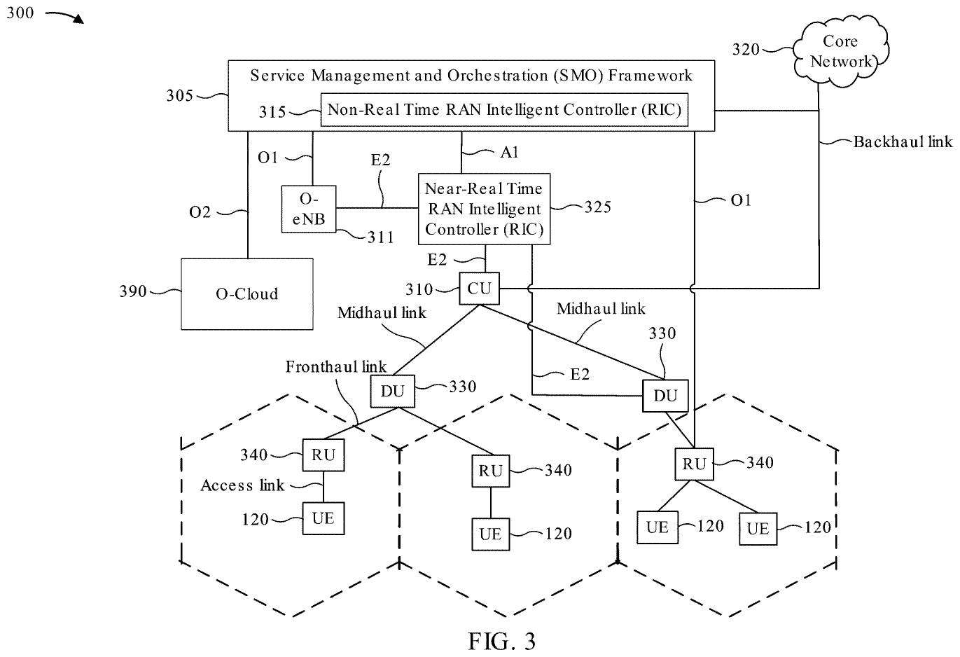

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as a RF transceiver), configured to receive or transmit signals, or both, over a wireless transmission medium to one or more of the other units.

In some aspects, the CU 310 may host one or more higher layer control functions. Such control functions can include RRC functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the El interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

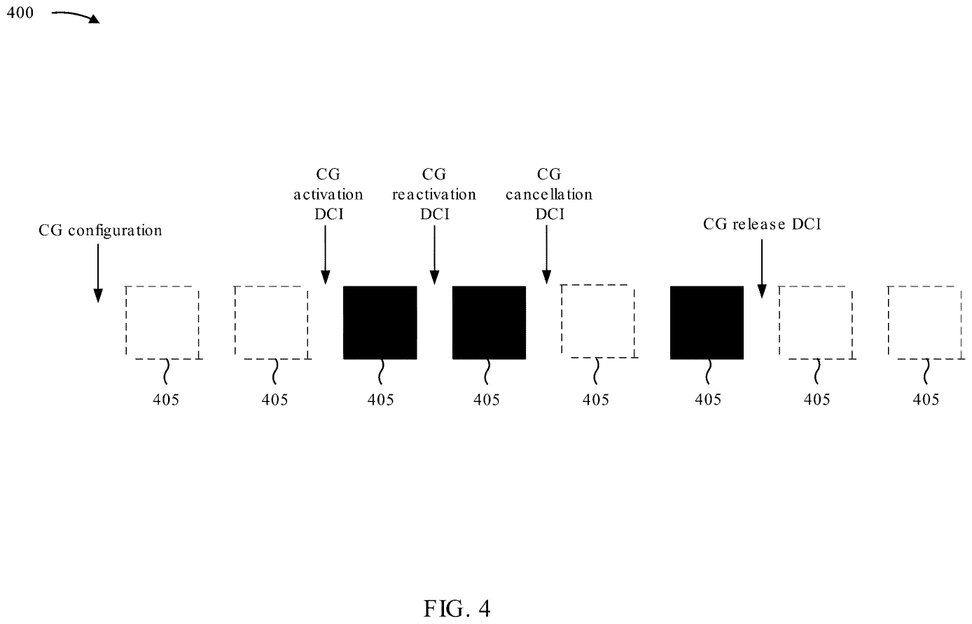

FIG. 4 is a diagram illustrating an example 400 of uplink CG communication, in accordance with the present disclosure. CG communications may include periodic uplink communications that are configured for a UE, such that the network node does not need to send separate downlink control information (DCI) to schedule each uplink communication, thereby conserving signaling overhead.

As shown in example 400, a UE may be configured with a CG configuration for CG communications. For example, the UE may receive the CG configuration via a radio resource control (RRC) message transmitted by a network node. The CG configuration may indicate a resource allocation associated with CG uplink communications (e.g., in a time domain, frequency domain, spatial domain, and/or code domain) and a periodicity at which the resource allocation is repeated, resulting in periodically reoccurring scheduled CG instances 405 for the UE. A CG instance 405 can include a CG occasion, a set of CG occasions, or a portion of a CG occasion. In some examples, the CG configuration may identify a resource pool or multiple resource pools that are available to the UE for an uplink transmission. The CG configuration may configure contention-free CG communications (e.g., where resources are dedicated for the UE to transmit uplink communications) or contention-based CG communications (e.g., where the UE contends for access to a channel in the configured resource allocation, such as by using a channel access procedure or a channel sensing procedure).

The network node may transmit CG activation DCI to the UE to activate the CG configuration for the UE. The network node may indicate, in the CG activation DCI, communication parameters, such as a modulation and coding scheme (MCS), a resource block (RB) allocation, and/or antenna ports, for the CG PUSCH communications to be transmitted in the scheduled CG instances 405. The UE may begin transmitting in the CG instances 405 based at least in part on receiving the CG activation DCI. For example, beginning with a next scheduled CG instance 405 subsequent to receiving the CG activation DCI, the UE may transmit a PUSCH communication in the scheduled CG instances 405 using the communication parameters indicated in the CG activation DCI. The UE may refrain from transmitting in configured CG instances 405 prior to receiving the CG activation DCI.

The network node may transmit CG reactivation DCI to the UE to change the communication parameters for the CG PUSCH communications. Based at least in part on receiving the CG reactivation DCI, the UE may begin transmitting in the scheduled CG instances 405 using the communication parameters indicated in the CG reactivation DCI. For example, beginning with a next scheduled CG instance 405 subsequent to receiving the CG reactivation DCI, the UE may transmit PUSCH communications in the scheduled CG instances 405 based at least in part on the communication parameters indicated in the CG reactivation DCI.

In some cases, such as when the network node needs to override a scheduled CG communication for a higher priority communication, the network node may transmit CG cancellation DCI to the UE to temporarily cancel or deactivate one or more subsequent CG instances 405 for the UE. The CG cancellation DCI may deactivate only a subsequent one CG instance 405 or a subsequent N CG instances 405 (where N is an integer). CG instances 405 after the one or more (e.g., N) CG instances 405 subsequent to the CG cancellation DCI may remain activated. Based at least in part on receiving the CG cancellation DCI, the UE may refrain from transmitting in the one or more (e.g., N) CG instances 405 subsequent to receiving the CG cancellation DCI. As shown in example 400, the CG cancellation DCI cancels one subsequent CG instance 405 for the UE. After the CG instances 405 (or N CG occasions) subsequent to receiving the CG cancellation DCI, the UE may automatically resume transmission in the scheduled CG instances 405.

The network node may transmit CG release DCI to the UE to deactivate the CG configuration for the UE. The UE may stop transmitting in the scheduled CG instances 405 based at least in part on receiving the CG release DCI. For example, the UE may refrain from transmitting in any scheduled CG instances 405 until another CG activation DCI is received from the network node. Whereas the CG cancellation DCI may deactivate only a subsequent one CG instance 405 or a subsequent N CG instances 405, the CG release DCI deactivates all subsequent CG instances 405 for a given CG configuration for the UE until the given CG configuration is activated again by a new CG activation DCI.

As indicated above, FIG. 4 is provided as an example. Other examples may differ from what is described with respect to FIG. 4.

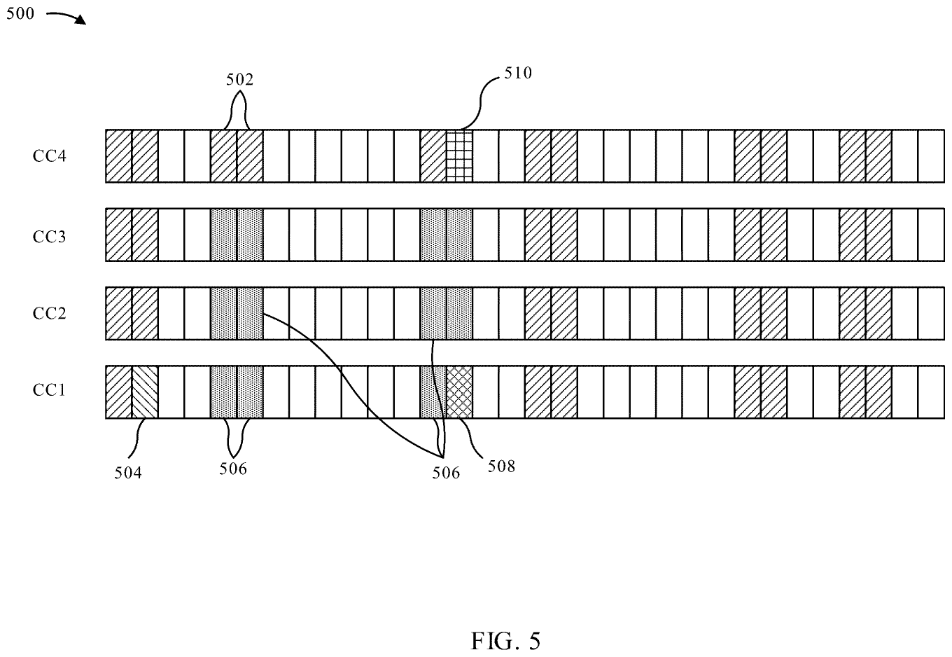

FIG. 5 is a diagram illustrating an example 500 associated with skipping CG PUSCH occasions, in accordance with the present disclosure. As shown, for example, a number of component carriers (CCs) (CC1, CC2, CC3, and CC4) may each be configured with a CG PUSCH configuration. Each CG PUSCH configuration may indicate a number of CG PUSCH occasions 502.

In some cases, a UE may multiplex UCI in a PUSCH occasion. For example, in some cases, a UE may be configured with a UCI multiplexing rule that dictates that if a UE transmits multiple PUSCH communications in a slot on respective serving cells (e.g., CCs) and the UE would multiplex UCI in one of the multiple PUSCH occasions and the UE does not multiplex aperiodic channel state information (CSI) in any of the multiple PUSCH occasions, the UE multiplexes the UCI in a PUSCH occasion of the serving cell with the smallest ServCellIndex subject to a set of conditions. If the UE transmits more than one PUSCH communication in the slot on the serving cell with the smallest ServCellIndex that fulfil the conditions for UCI multiplexing, the UE can multiplex the UCI in the earliest PUSCH occasion in which the UE transmits in the slot.

In some cases, the UE may transmit, in a PUSCH occasion 504, a PUSCH communication that includes an indication (a “skipping indication”) associated with one or more skipped CG PUCSH occasions 506. Due to the UCI multiplexing rule, in an example, the UCI may be scheduled to be transmitted in a CG PUSCH occasion 508. However, as the UE may skip the CG PUSCH occasion 508, the UE may, instead multiplex the UCI in a CG PUSCH occasion 510, that is not skipped. However, in some cases, a transmitted skipping indication may be lost and not received by the network node, in which case, the network node would not be aware that the UCI is to be multiplexed in the CG PUSCH occasion 510 instead of the CG PUSCH occasion 508.

Accordingly, the UCI also may not be received by the network node. In this way, CG PUSCH occasion skipping can causes misalignment between the UE and the network node for UCI multiplexing, resulting in inefficient and unreliable communications, and thereby negatively impacting network performance.

Some aspects of the techniques and apparatuses described herein provide support for indicating skipping CG occasions for PUSCH. For example, in some aspects, a UE may transmit, in a first PUSCH occasion, a first PUSCH communication including an indication associated with at least one skipped CG occasion. In some aspects, the UE may receive a scheduling communication that indicates a second PUSCH occasion for a re-transmission of the first PUSCH communication and may transmit, in the second PUSCH occasion, a second PUSCH communication, the second PUSCH communication including a re-transmission of the first PUSCH communication and the indication associated with the at least one skipped CG occasion. In this way, the reliability of indicating skipped CG PUSCH occasions may be improved. In some aspects, the UE may receive a confirmation communication that indicates reception, by a network node, of the indication associated with the at least one skipped CG occasion. In this way, reliability of indicating skipped CG PUSCH occasions may be improved. In some aspects, the UE may transmit, in an unskipped CG occasion of the at least one CG occasion, an uplink communication including UCI multiplexed with a second PUSCH communication. In this way, alignment and reliability of UCI multiplexing in CG PUSCH occasions can be improved. Thus, some aspects may facilitate efficient and reliable communications, and thereby positively impact network performance.

As indicated above, FIG. 5 is provided as an example. Other examples may differ from what is described with respect to FIG. 5.

FIGS. 6A-6C are diagrams illustrating examples 600 associated with techniques for indicating skipping CG occasions for PUSCH, in accordance with the present disclosure. As shown in FIG. 6A, a UE 602 and a network node 604 may communicate with one another. In some aspects, the UE 602 may be, be similar to, include, or be included in, the UE 120 depicted in FIGS. 1-3. In some aspects, the network node 604 may be, be similar to, include, or be included in, the network node 110 depicted in FIGS. 1 and 2, and/or one or more aspects of the disaggregated base station architecture 300 depicted in FIG. 3.

As shown by reference number 606, the network node 604 may transmit, and the UE 602 may receive, configuration information. For example, the configuration information may be transmitted using an RRC message and may include an uplink CG configuration. In some aspects, the uplink CG configuration may indicate one or more CG occasions for PUSCH transmissions. The uplink CG configuration also may indicate one or more parameters associated with skipping CG PUSCH occasions. In some aspects, the configuration information may indicate an application time associated with skipping CG occasions. For example, as shown, a CG configuration 608 may include an application time 610 that is defined by a time period between a start time 612 and an end time 614 at which a first CG PUSCH occasion 616 can be skipped. After the end time 614, any number of additional CG PUSCH occasions 618, of a plurality of configured CG PUSCH occasions 620, can be skipped. In some aspects, the configuration information may indicate the start time 612. For example, the start time 612 may be a time associated with a transmission of a PUSCH communication. For example, the start time 612 may correspond to an end of a PUSCH occasion 622 in which a first PUSCH communication is transmitted. In some aspects, the PUSCH communication may include an indication associated with at least one skipped CG occasion (sometimes referred to as a “skipping indication”). In some aspects, as shown, a CG configuration 624 may include an application time 626 having a start time 628 associated with reception (e.g., an end of a downlink occasion 630), by the UE 602, of a confirmation communication from the network node 604. In some aspects, the application time may be specified by a wireless communication standard and stored in a memory of the UE 602.

In some aspects, the configuration information may indicate whether a CG configuration is skippable or unskippable. A CG configuration that is unskippable is a CG configuration that indicates one or more CG occasions that cannot be skipped-e.g., the UE 602 is configured to transmit an uplink communication in each CG occasion. In some aspects, the configuration information may indicate a CG configuration that is skippable. A CG configuration that is skippable is a CG configuration that indicates one or more CG occasions that can be skipped-e.g., the UE 602 may skip (e.g., refrain from transmitting a communication in) one or more CG occasions of the configuration. In some aspects, a configuration may indicate a combination of skippable and unskippable CG occasions. For example, in some aspects, the configuration information may indicate a number of CG configurations, each corresponding to a respective component carrier. Each of the CG configurations may be configured as skippable or unskippable.

As shown by reference number 632, the UE 602 may transmit, and the network node 604 may receive, a first PUSCH communication. In some aspects, the first PUSCH communication may be transmitted in the first PUSCH occasion 622. In some aspects, the first PUSCH occasion 622 may include a CG PUSCH occasion. In some aspects, the first PUSCH occasion 622 may include a dynamic grant PUSCH occasion. In some aspects, the first PUSCH communication may include an indication associated with at least one skipped CG occasion (e.g., a “skipping indication”). In some aspects, the at least one skipped CG occasion may include a CG occasion associated with a CG configuration. The first PUSCH occasion 622 may be a PUSCH occasion of a plurality of PUSCH occasions indicated by the configuration information.

In some aspects, the configuration information may indicate whether a CG configuration is feasible for UCI multiplexing or not feasible for UCI multiplexing. When a CG configuration is feasible for UCI multiplexing, the UE 602 may multiplex UCI such as acknowledgement and/or negative acknowledgement (ACK/NCK) feedback and/or channel state information (CSI) with the skipping indication in a CG PUSCH occasion. When a CG configuration is not feasible for UCI multiplexing, the UE 602 may not multiplex UCI such as ACK/NCK and/or CSI with the skipping indication in a CG PUSCH occasion.

As shown by reference number 634, in some aspects, the network node 604 may transmit, and the UE 602 may receive, a scheduling communication. The scheduling communication may indicate a second PUSCH occasion 636 for a re-transmission of the first PUSCH communication. As shown by reference number 638, in some aspects, the network node 604 may transmit, and the UE 602 may receive, the confirmation communication. The confirmation communication may indicate reception, by the network node 604, of the indication associated with the at least one skipped CG occasion. In some aspects, the confirmation communication may include DCI and/or a medium access control control element (MAC CE). For example, in some aspects, the confirmation communication may be transmitted in the downlink occasion 630, as indicated above. In aspects in which the confirmation communication is DCI, the DCI may be an uplink non-scheduling DCI. For example, the DCI may have a DCI format 0_1 or 1_2 without any uplink data assignment and/or CSI request.

As shown by reference number 640, the UE 602 may transmit, and the network node 604 may receive, a second PUSCH communication. In some aspects, the second PUSCH communication may include a re-transmission of the first PUSCH communication. For example, as shown in CG configuration 608, the second PUSCH communication may be transmitted in the second PUSCH occasion 636. In some aspects, the second PUSCH communication may include the indication associated with the at least one skipped CG occasion.

In some aspects, the second PUSCH communication may be multiplexed with UCI. For example, FIG. 6B is a diagram illustrating an example 644 associated with techniques for indicating skipping CG occasions for PUSCH in which each of a number of component carriers (CCs) may correspond to respective CG configurations that may be configured to be skippable and/or unskippable. In some aspects, for example, CC1 may correspond to a CG configuration that is skippable, CC2 may correspond to a CG configuration that is skippable, CC3 may correspond to a CG configuration that is unskippable, and CC4 may correspond to a CG configuration that is unskippable.

In some aspects, the UE 602 may exclude, from being considered for transmission of a PUSCH communication multiplexed with UCI, any CG occasion associated with a CG configuration that is configured as skippable (e.g., whether or not the excluded CG occasion is actually skipped). For example, the UE 602 may refrain from multiplexing UCI in any skippable CG occasion. As shown for example, CG PUSCH occasions 646 may be skipped since CC1 corresponds to a CG configuration that is skippable. An indication transmitted in the PUSCH occasion 648 may indicate the skipped CG occasions. Because CC3 corresponds to a CG configuration that is unskippable, the UE 602 may transmit, in a CG occasion 650, for example, a PUSCH communication multiplexed with UCI.

In some aspects, if there is UCI to be multiplexed in a CG PUSCH occasion, the UE 602 may be configured to not skip the CG PUSCH occasion, even if that CG PUSCH occasion is indicated as a skipped CG PUSCH occasion. For example, FIG. 6C is another diagram illustrating an example 652 associated with techniques for indicating skipping CG occasions for PUSCH in which each of a number of CCs may correspond to respective CG configurations that may be configured to be skippable and/or unskippable. For example, in example 652, all of the CCS (CC1, CC2, CC3, and CC4) correspond to CG configurations that are configured as skippable. A PUSCH communication that includes an indication associated with at least one skipped CG PUSCH occasion may be transmitted by the UE 602 in a PUSCH occasion 654. The indication may indicate the CG PUSCH occasions 656 as being skipped CG PUSCH occasions. However, a CG PUSCH occasion 658 may be scheduled to be used to transmit UCI (e.g., multiplexed with a PUSCH communication). Accordingly, the UE 602 may not skip the CG PUSCH occasion 658 and may transmit the PUSCH communication multiplexed with the UCI in the CG PUSCH occasion 658.

As indicated above, FIGS. 6A-6C are provided as examples. Other examples may differ from what is described with respect to FIGS. 6A-6C.

FIG. 7 is a diagram illustrating an example process 700 performed, for example, by a UE, in accordance with the present disclosure. Example process 700 is an example where the UE (e.g., UE 602) performs operations associated with techniques for indicating skipping CG occasions for PUSCH.

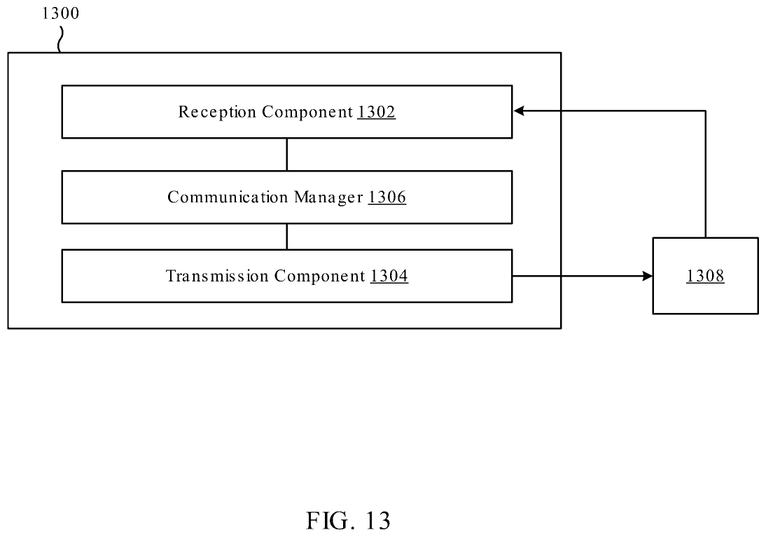

As shown in FIG. 7, in some aspects, process 700 may include transmitting, in a first PUSCH occasion, a first PUSCH communication including an indication associated with at least one skipped CG occasion (block 710). For example, the UE (e.g., using transmission component 1304 and/or communication manager 1306, depicted in FIG. 13) may transmit, in a first PUSCH occasion, a first PUSCH communication including an indication associated with at least one skipped CG occasion, as described above.

As further shown in FIG. 7, in some aspects, process 700 may include receiving a scheduling communication that indicates a second PUSCH occasion for a re-transmission of the first PUSCH communication (block 720). For example, the UE (e.g., using reception component 1302 and/or communication manager 1306, depicted in FIG. 13) may receive a scheduling communication that indicates a second PUSCH occasion for a re-transmission of the first PUSCH communication, as described above.

As further shown in FIG. 7, in some aspects, process 700 may include transmitting, in the second PUSCH occasion, a second PUSCH communication, the second PUSCH communication including a re-transmission of the first PUSCH communication and the indication associated with the at least one skipped CG occasion (block 730). For example, the UE (e.g., using transmission component 1304 and/or communication manager 1306, depicted in FIG. 13) may transmit, in the second PUSCH occasion, a second PUSCH communication, the second PUSCH communication including a re-transmission of the first PUSCH communication and the indication associated with the at least one skipped CG occasion, as described above.

Process 700 may include additional aspects, such as any single aspect or any combination of aspects described below and/or in connection with one or more other processes described elsewhere herein.

In a first aspect, an application time associated with a first skipped CG occasion of the at least one skipped CG occasion comprises a start time associated with the transmission of the first PUSCH communication. In a second aspect, alone or in combination with the first aspect, at least one of the first PUSCH occasion or the second PUSCH occasion comprises a CG PUSCH occasion. In a third aspect, alone or in combination with the first aspect, at least one of the first PUSCH occasion or the second PUSCH occasion comprises a dynamic grant PUSCH occasion.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a network node, in accordance with the present disclosure. Example process 800 is an example where the network node (e.g., network node 604) performs operations associated with techniques for indicating skipping CG occasions for PUSCH.

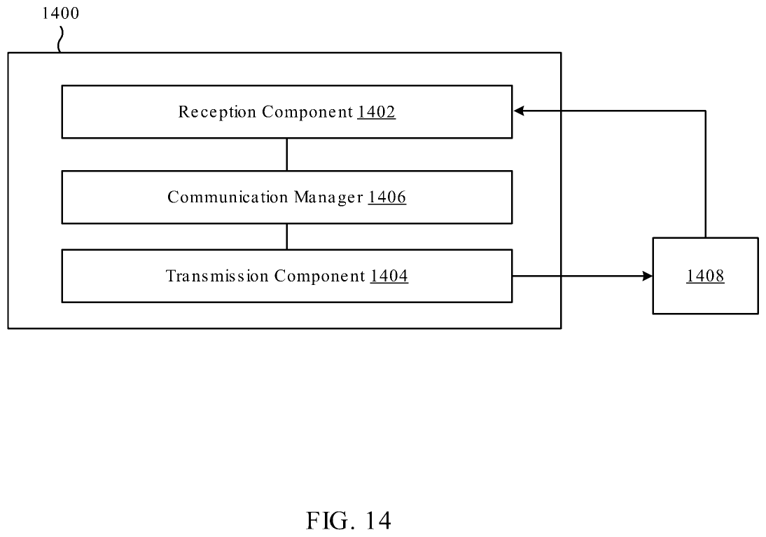

As shown in FIG. 8, in some aspects, process 800 may include receiving, in a first PUSCH occasion, a first PUSCH communication including an indication associated with at least one skipped CG occasion (block 810). For example, the network node (e.g., using reception component 1402 and/or communication manager 1406, depicted in FIG. 14) may receive, in a first PUSCH occasion, a first PUSCH communication including an indication associated with at least one skipped CG occasion, as described above.

As further shown in FIG. 8, in some aspects, process 800 may include transmitting a scheduling communication that indicates a second PUSCH occasion for a re-transmission of the first PUSCH communication (block 820). For example, the network node (e.g., using transmission component 1404 and/or communication manager 1406, depicted in FIG. 14) may transmit a scheduling communication that indicates a second PUSCH occasion for a re-transmission of the first PUSCH communication, as described above.

As further shown in FIG. 8, in some aspects, process 800 may include receiving, in the second PUSCH occasion, a second PUSCH communication, the second PUSCH communication including a re-transmission of the first PUSCH communication and the indication associated with the at least one skipped CG occasion (block 830). For example, the network node (e.g., using reception component 1402 and/or communication manager 1406, depicted in FIG. 14) may receive, in the second PUSCH occasion, a second PUSCH communication, the second PUSCH communication including a re-transmission of the first PUSCH communication and the indication associated with the at least one skipped CG occasion, as described above.

Process 800 may include additional aspects, such as any single aspect or any combination of aspects described below and/or in connection with one or more other processes described elsewhere herein.

In a first aspect, an application time associated with a first skipped CG occasion of the at least one skipped CG occasion comprises a start time associated with the transmission of the first PUSCH communication. In a second aspect, alone or in combination with the first aspect, at least one of the first PUSCH occasion or the second PUSCH occasion comprises a CG PUSCH occasion. In a third aspect, alone or in combination with the first aspect, at least one of the first PUSCH occasion or the second PUSCH occasion comprises a dynamic grant PUSCH occasion.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a UE, in accordance with the present disclosure. Example process 900 is an example where the UE (e.g., UE 602) performs operations associated with techniques for indicating skipping CG occasions for PUSCH.

As shown in FIG. 9, in some aspects, process 900 may include transmitting, in a PUSCH occasion, a PUSCH communication including an indication associated with at least one skipped CG occasion (block 910). For example, the UE (e.g., using transmission component 1304 and/or communication manager 1306, depicted in FIG. 13) may transmit, in a PUSCH occasion, a PUSCH communication including an indication associated with at least one skipped CG occasion, as described above.

As further shown in FIG. 9, in some aspects, process 900 may include receiving a confirmation communication that indicates reception of the indication associated with the at least one skipped CG occasion (block 920). For example, the UE (e.g., using reception component 1302 and/or communication manager 1306, depicted in FIG. 13) may receive a confirmation communication that indicates reception of the indication associated with the at least one skipped CG occasion, as described above.

Process 900 may include additional aspects, such as any single aspect or any combination of aspects described below and/or in connection with one or more other processes described elsewhere herein.

In a first aspect, the confirmation communication comprises DCI. In a second aspect, alone or in combination with the first aspect, the confirmation communication comprises a MAC CE. In a third aspect, alone or in combination with one or more of the first and second aspects, an application time associated with a first skipped CG occasion of the at least one skipped CG occasion comprises a start time associated with the transmission of the PUSCH communication. In a fourth aspect, alone or in combination with one or more of the first and second aspects, an application time associated with a first skipped CG occasion of the at least one skipped CG occasion comprises a start time associated with the reception of the confirmation communication.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a network node, in accordance with the present disclosure. Example process 1000 is an example where the network node (e.g., network node 604) performs operations associated with techniques for indicating skipping CG occasions for PUSCH.

As shown in FIG. 10, in some aspects, process 1000 may include receiving, in a PUSCH occasion, a PUSCH communication including an indication associated with at least one skipped CG occasion (block 1010). For example, the network node (e.g., using reception component 1402 and/or communication manager 1406, depicted in FIG. 14) may receive, in a PUSCH occasion, a PUSCH communication including an indication associated with at least one skipped CG occasion, as described above.

As further shown in FIG. 10, in some aspects, process 1000 may include transmitting a confirmation communication that indicates reception of the indication associated with the at least one skipped CG occasion (block 1020). For example, the network node (e.g., using transmission component 1404 and/or communication manager 1406, depicted in FIG. 14) may transmit a confirmation communication that indicates reception of the indication associated with the at least one skipped CG occasion, as described above.

Process 1000 may include additional aspects, such as any single aspect or any combination of aspects described below and/or in connection with one or more other processes described elsewhere herein.

In a first aspect, the confirmation communication comprises downlink control information. In a second aspect, alone or in combination with the first aspect, the confirmation communication comprises a downlink medium access control control element. In a third aspect, alone or in combination with one or more of the first and second aspects, an application time associated with a first skipped CG occasion of the at least one skipped CG occasion comprises a start time associated with the reception of the PUSCH communication. In a fourth aspect, alone or in combination with one or more of the first and second aspects, an application time associated with a first skipped CG occasion of the at least one skipped CG occasion comprises a start time associated with the transmission of the confirmation communication.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a UE, in accordance with the present disclosure. Example process 1100 is an example where the UE (e.g., UE 602) performs operations associated with techniques for indicating skipping CG occasions for PUSCH.

As shown in FIG. 11, in some aspects, process 1100 may include transmitting, in a PUSCH occasion, a first PUSCH communication including an indication associated with at least one skipped CG occasion (block 1110). For example, the UE (e.g., using transmission component 1304 and/or communication manager 1306, depicted in FIG. 13) may transmit, in a PUSCH occasion, a first PUSCH communication including an indication associated with at least one skipped CG occasion, as described above.

As further shown in FIG. 11, in some aspects, process 1100 may include transmitting, in an unskipped CG occasion of the at least one CG occasion, an uplink communication including uplink control information (UCI) multiplexed with a second PUSCH communication (block 1120). For example, the UE (e.g., using transmission component 1304 and/or communication manager 1306, depicted in FIG. 13) may transmit, in an unskipped CG occasion of the at least one CG occasion, an uplink communication including uplink control information (UCI) multiplexed with a second PUSCH communication, as described above.

Process 1100 may include additional aspects, such as any single aspect or any combination of aspects described below and/or in connection with one or more other processes described elsewhere herein.

In some aspects, if the UE is configured with a parameter (e.g., an enhancedSkipUplinkTxConfigured parameter) with value true and the grant for a PUSCH is a configured uplink grant, and is indicated as an unused grant occasion by the UE, if there is a UCI including the skipping indication to be multiplexed on the configured uplink grant, the UE may transmit the PUSCH for the grant.

In a first aspect, the unskipped CG occasion is associated with a CG configuration that is configured as unskippable. In a second aspect, alone or in combination with the first aspect, the unskipped CG occasion is associated with a CG configuration that is configured as skippable. In a third aspect, alone or in combination with one or more of the first and second aspects, the unskipped CG occasion is associated with a component carrier of a plurality of component carriers. In a fourth aspect, alone or in combination with one or more of the first through third aspects, process 1100 includes refraining from multiplexing UCI in any CG occasion, of the at least one CG occasion, that is configured as skippable. In a fifth aspect, alone or in combination with one or more of the first through fourth aspects, the skipping indication indicates the unskipped CG occasion as being skipped.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, by a network node, in accordance with the present disclosure. Example process 1200 is an example where the network node (e.g., network node 604) performs operations associated with techniques for indicating skipping CG occasions for PUSCH.

As shown in FIG. 12, in some aspects, process 1200 may include receiving, in a PUSCH occasion, a first PUSCH communication including an indication associated with at least one skipped CG occasion (block 1210). For example, the network node (e.g., using reception component 1402 and/or communication manager 1406, depicted in FIG. 14) may receive, in a PUSCH occasion, a first PUSCH communication including an indication associated with at least one skipped CG occasion, as described above.

As further shown in FIG. 12, in some aspects, process 1200 may include receiving, in an unskipped CG occasion of the at least one CG occasion, an uplink communication comprising uplink control information (UCI) multiplexed with a second PUSCH communication (block 1220). For example, the network node (e.g., using reception component 1402 and/or communication manager 1406, depicted in FIG. 14) may receive, in an unskipped CG occasion of the at least one CG occasion, an uplink communication comprising uplink control information (UCI) multiplexed with a second PUSCH communication, as described above.

Process 1200 may include additional aspects, such as any single aspect or any combination of aspects described below and/or in connection with one or more other processes described elsewhere herein.

In a first aspect, the unskipped CG occasion is associated with a CG configuration that is configured as unskippable. In a second aspect, alone or in combination with the first aspect, the unskipped CG occasion is associated with a CG configuration that is configured as skippable. In a third aspect, alone or in combination with one or more of the first and second aspects, the unskipped CG occasion is associated with a component carrier of a plurality of component carriers. In a fourth aspect, alone or in combination with one or more of the first through third aspects, the skipping indication indicates the unskipped CG occasion as being skipped.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram of an example apparatus 1300 for wireless communication, in accordance with the present disclosure. The apparatus 1300 may be a UE, or a UE may include the apparatus 1300. In some aspects, the apparatus 1300 includes a reception component 1302, a transmission component 1304, and/or a communication manager 1306, which may be in communication with one another (for example, via one or more buses and/or one or more other components). In some aspects, the communication manager 1306 is the communication manager 140 described in connection with FIG. 1. As shown, the apparatus 1300 may communicate with another apparatus 1308, such as a UE or a network node (such as a CU, a DU, an RU, or a base station), using the reception component 1302 and the transmission component 1304.

In some aspects, the apparatus 1300 may be configured to perform one or more operations described herein in connection with FIGS. 6A-6C. Additionally, or alternatively, the apparatus 1300 may be configured to perform one or more processes described herein, such as process 700 of FIG. 7, process 900 of FIG. 9, process 1100 of FIG. 11, or a combination thereof. In some aspects, the apparatus 1300 and/or one or more components shown in FIG. 13 may include one or more components of the UE described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1308. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the UE described in connection with FIG. 2.

The transmission component 1304 may transmit communications, such as reference signals, control information, data communications, or a combination thereof, to the apparatus 1308. In some aspects, one or more other components of the apparatus 1300 may generate communications and may provide the generated communications to the transmission component 1304 for transmission to the apparatus 1308. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1308. In some aspects, the transmission component 1304 may include one or more antennas, a modem, a modulator, a transmit MIMO processor, a transmit processor, a controller/processor, a memory, or a combination thereof, of the UE described in connection with FIG. 2. In some aspects, the transmission component 1304 may be co-located with the reception component 1302 in a transceiver.

The communication manager 1306 may support operations of the reception component 1302 and/or the transmission component 1304. For example, the communication manager 1306 may receive information associated with configuring reception of communications by the reception component 1302 and/or transmission of communications by the transmission component 1304. Additionally, or alternatively, the communication manager 1306 may generate and/or provide control information to the reception component 1302 and/or the transmission component 1304 to control reception and/or transmission of communications.

In some examples, means for transmitting, outputting, or sending (or means for outputting for transmission) may include one or more antennas, a modulator, a transmit MIMO processor, a transmit processor, or a combination thereof, of the UE described above in connection with FIG. 2.

In some examples, means for receiving (or means for obtaining) may include one or more antennas, a demodulator, a MIMO detector, a receive processor, or a combination thereof, of the UE described above in connection with FIG. 2.

In some cases, rather than actually transmitting, for example, signals and/or data, a device may have an interface to output signals and/or data for transmission (a means for outputting). For example, a processor may output signals and/or data, via a bus interface, to an RF front end for transmission. Similarly, rather than actually receiving signals and/or data, a device may have an interface to obtain the signals and/or data received from another device (a means for obtaining). For example, a processor may obtain (or receive) the signals and/or data, via a bus interface, from an RF front end for reception. In various aspects, an RF front end may include various components, including transmit and receive processors, transmit and receive MIMO processors, modulators, demodulators, and the like, such as depicted in the examples in FIG. 2.

In some examples, means for obtaining, receiving, outputting, transmitting, determining, refraining, omitting, multiplexing, and/or processing may include various processing system components, such as a receive processor, a transmit processor, a controller/processor, a memory, or a combination thereof, of the UE described above in connection with FIG. 2.

The transmission component 1304 may transmit, in a first PUSCH occasion, a first PUSCH communication including an indication associated with at least one skipped CG occasion. The reception component 1302 may receive a scheduling communication that indicates a second PUSCH occasion for a re-transmission of the first PUSCH communication. The transmission component 1304 may transmit, in the second PUSCH occasion, a second PUSCH communication, the second PUSCH communication including a re-transmission of the first PUSCH communication and the indication associated with the at least one skipped CG occasion. The transmission component 1304 may transmit, in a PUSCH occasion, a PUSCH communication including an indication associated with at least one skipped CG occasion. The reception component 1302 may receive a confirmation communication that indicates reception of the indication associated with the at least one skipped CG occasion.

The transmission component 1304 may transmit, in a PUSCH occasion, a first PUSCH communication including an indication associated with at least one skipped CG occasion. The transmission component 1304 may transmit, in an unskipped CG occasion of the at least one CG occasion, an uplink communication including uplink control information (UCI) multiplexed with a second PUSCH communication. The communication manager 1306 may refrain from multiplexing UCI in any CG occasion, of the at least one CG occasion, that is configured as skippable.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

FIG. 14 is a diagram of an example apparatus 1400 for wireless communication, in accordance with the present disclosure. The apparatus 1400 may be a network node, or a network node may include the apparatus 1400. In some aspects, the apparatus 1400 includes a reception component 1402, a transmission component 1404, and/or a communication manager 1406, which may be in communication with one another (for example, via one or more buses and/or one or more other components). In some aspects, the communication manager 1406 is the communication manager 150 described in connection with FIG. 1. As shown, the apparatus 1400 may communicate with another apparatus 1408, such as a UE or a network node (such as a CU, a DU, an RU, or a base station), using the reception component 1402 and the transmission component 1404.

In some aspects, the apparatus 1400 may be configured to perform one or more operations described herein in connection with FIGS. 6A-6C. Additionally, or alternatively, the apparatus 1400 may be configured to perform one or more processes described herein, such as process 800 of FIG. 8, process 1000 of FIG. 10, process 1200 of FIG. 12, or a combination thereof. In some aspects, the apparatus 1400 and/or one or more components shown in FIG. 14 may include one or more components of the network node described in connection with FIG. 2. Additionally, or alternatively, one or more components shown in FIG. 14 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1402 may receive communications, such as reference signals, control information, data communications, or a combination thereof, from the apparatus 1408. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1400. In some aspects, the reception component 1402 may include one or more antennas, a modem, a demodulator, a MIMO detector, a receive processor, a controller/processor, a memory, or a combination thereof, of the network node described in connection with FIG. 2. In some aspects, the reception component 1402 and/or the transmission component 1404 may include or may be included in a network interface. The network interface may be configured to obtain and/or output signals for the apparatus 1400 via one or more communications links, such as a backhaul link, a midhaul link, and/or a fronthaul link.

The transmission component 1404 may transmit communications, such as reference signals, control information, data communications, or a combination thereof, to the apparatus 1408. In some aspects, one or more other components of the apparatus 1400 may generate communications and may provide the generated communications to the transmission component 1404 for transmission to the apparatus 1408. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1408. In some aspects, the transmission component 1404 may include one or more antennas, a modem, a modulator, a transmit MIMO processor, a transmit processor, a controller/processor, a memory, or a combination thereof, of the network node described in connection with FIG. 2. In some aspects, the transmission component 1404 may be co-located with the reception component 1402 in a transceiver.

The communication manager 1406 may support operations of the reception component 1402 and/or the transmission component 1404. For example, the communication manager 1406 may receive information associated with configuring reception of communications by the reception component 1402 and/or transmission of communications by the transmission component 1404. Additionally, or alternatively, the communication manager 1406 may generate and/or provide control information to the reception component 1402 and/or the transmission component 1404 to control reception and/or transmission of communications.

In some examples, means for transmitting, outputting, or sending (or means for outputting for transmission) may include one or more antennas, a modulator, a transmit MIMO processor, a transmit processor, or a combination thereof, of the network node described above in connection with FIG. 2.

In some examples, means for receiving (or means for obtaining) may include one or more antennas, a demodulator, a MIMO detector, a receive processor, or a combination thereof, of the network node described above in connection with FIG. 2.

In some cases, rather than actually transmitting, for example, signals and/or data, a device may have an interface to output signals and/or data for transmission (a means for outputting). For example, a processor may output signals and/or data, via a bus interface, to an RF front end for transmission. Similarly, rather than actually receiving signals and/or data, a device may have an interface to obtain the signals and/or data received from another device (a means for obtaining). For example, a processor may obtain (or receive) the signals and/or data, via a bus interface, from an RF front end for reception. In various aspects, an RF front end may include various components, including transmit and receive processors, transmit and receive MIMO processors, modulators, demodulators, and the like, such as depicted in the examples in FIG. 2.

In some examples, means for obtaining, receiving, outputting, transmitting, determining, refraining, omitting, multiplexing, and/or processing may include various processing system components, such as a receive processor, a transmit processor, a controller/processor, a memory, or a combination thereof, of the network node described above in connection with FIG. 2.

The reception component 1402 may receive, in a first PUSCH occasion, a first PUSCH communication including an indication associated with at least one skipped CG occasion. The transmission component 1404 may transmit a scheduling communication that indicates a second PUSCH occasion for a re-transmission of the first PUSCH communication. The reception component 1402 may receive, in the second PUSCH occasion, a second PUSCH communication, the second PUSCH communication including a re-transmission of the first PUSCH communication and the indication associated with the at least one skipped CG occasion. The reception component 1402 may receive, in a PUSCH occasion, a PUSCH communication including an indication associated with at least one skipped CG occasion. The transmission component 1404 may transmit a confirmation communication that indicates reception of the indication associated with the at least one skipped CG occasion.

The reception component 1402 may receive, in a PUSCH occasion, a first PUSCH communication including an indication associated with at least one skipped CG occasion. The reception component 1402 may receive, in an unskipped CG occasion of the at least one CG occasion, an uplink communication comprising uplink control information (UCI) multiplexed with a second PUSCH communication.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

The following provides an overview of some Aspects of the present disclosure:
Aspect 1: A method of wireless communication performed by a user equipment (UE), comprising: transmitting, in a first physical uplink shared channel (PUSCH) occasion, a first PUSCH communication including an indication associated with at least one skipped configured grant (CG) occasion; receiving a scheduling communication that indicates a second PUSCH occasion for a re-transmission of the first PUSCH communication; and transmitting, in the second PUSCH occasion, a second PUSCH communication, the second PUSCH communication including a re-transmission of the first PUSCH communication and the indication associated with the at least one skipped CG occasion.
Aspect 2: The method of Aspect 1, wherein an application time associated with a first skipped CG occasion of the at least one skipped CG occasion comprises a start time associated with the transmission of the first PUSCH communication.
Aspect 3: The method of either of claims 1 or 2, wherein at least one of the first PUSCH occasion or the second PUSCH occasion comprises a CG PUSCH occasion.
Aspect 4: The method of either of claims 1 or 2, wherein at least one of the first PUSCH occasion or the second PUSCH occasion comprises a dynamic grant PUSCH occasion.
Aspect 5: A method of wireless communication performed by a network node, comprising: receiving, in a first physical uplink shared channel (PUSCH) occasion, a first PUSCH communication including an indication associated with at least one skipped configured grant (CG) occasion; transmitting a scheduling communication that indicates a second PUSCH occasion for a re-transmission of the first PUSCH communication; and receiving, in the second PUSCH occasion, a second PUSCH communication, the second PUSCH communication including a re-transmission of the first PUSCH communication and the indication associated with the at least one skipped CG occasion.
Aspect 6: The method of Aspect 5, wherein an application time associated with a first skipped CG occasion of the at least one skipped CG occasion comprises a start time associated with the transmission of the first PUSCH communication.
Aspect 7: The method of either of claims 5 or 6, wherein at least one of the first PUSCH occasion or the second PUSCH occasion comprises a CG PUSCH occasion.
Aspect 8: The method of either of claims 5 or 6, wherein at least one of the first PUSCH occasion or the second PUSCH occasion comprises a dynamic grant PUSCH occasion.
Aspect 9: A method of wireless communication performed by a user equipment (UE), comprising: transmitting, in a physical uplink shared channel (PUSCH) occasion, a PUSCH communication including an indication associated with at least one skipped configured grant (CG) occasion; and receiving a confirmation communication that indicates reception, by a network node, of the indication associated with the at least one skipped CG occasion.
Aspect 10: The method of Aspect 9, wherein the confirmation communication comprises downlink control information.
Aspect 11: The method of either of claims 9 or 10, wherein the confirmation communication comprises a downlink medium access control control element.
Aspect 12: The method of any of Aspects 9-11, wherein an application time associated with a first skipped CG occasion of the at least one skipped CG occasion comprises a start time associated with the transmission of the PUSCH communication.
Aspect 13: The method of any of Aspects 9-11, wherein an application time associated with a first skipped CG occasion of the at least one skipped CG occasion comprises a start time associated with the reception of the confirmation communication.
Aspect 14: A method of wireless communication performed by a network node, comprising: receiving, in a physical uplink shared channel (PUSCH) occasion, a PUSCH communication including an indication associated with at least one skipped configured grant (CG) occasion; and transmitting a confirmation communication that indicates reception, by a network node, of the indication associated with the at least one skipped CG occasion.
Aspect 15: The method of Aspect 14, wherein the confirmation communication comprises downlink control information.
Aspect 16: The method of either of claims 14 or 15, wherein the confirmation communication comprises a downlink medium access control control element.
Aspect 17: The method of any of Aspects 14-16, wherein an application time associated with a first skipped CG occasion of the at least one skipped CG occasion comprises a start time associated with the reception of the PUSCH communication.
Aspect 18: The method of any of Aspects 14-16, wherein an application time associated with a first skipped CG occasion of the at least one skipped CG occasion comprises a start time associated with the transmission of the confirmation communication.
Aspect 19: A method of wireless communication performed by a user equipment (UE), comprising: transmitting, in a physical uplink shared channel (PUSCH) occasion, a first PUSCH communication including an indication associated with at least one skipped configured grant (CG) occasion; and transmitting, in an unskipped CG occasion of the at least one CG occasion, an uplink communication including uplink control information (UCI) multiplexed with a second PUSCH communication.
Aspect 20: The method of Aspect 19, wherein the unskipped CG occasion is associated with a CG configuration that is configured as unskippable.
Aspect 21: The method of any of Aspects 19-20, wherein the unskipped CG occasion is associated with a CG configuration that is configured as skippable.
Aspect 22: The method of any of Aspects 19-21, wherein the unskipped CG occasion is associated with a component carrier of a plurality of component carriers.
Aspect 23: The method of any of Aspects 19-22, further comprising refraining from multiplexing UCI in any CG occasion, of the at least one CG occasion, that is configured as skippable.
Aspect 24: The method of any of Aspects 19-23, wherein the skipping indication indicates the unskipped CG occasion as being skipped.
Aspect 25: A method of wireless communication performed by a network node, comprising: receiving, in a physical uplink shared channel (PUSCH) occasion, a first PUSCH communication including an indication associated with at least one skipped configured grant (CG) occasion; and receiving, in an unskipped CG occasion of the at least one CG occasion, an uplink communication comprising uplink control information (UCI) multiplexed with a second PUSCH communication.
Aspect 26: The method of Aspect 25, wherein the unskipped CG occasion is associated with a CG configuration that is configured as unskippable.
Aspect 27: The method of any of Aspects 25-26, wherein the unskipped CG occasion is associated with a CG configuration that is configured as skippable.
Aspect 28: The method of any of Aspects 25-27, wherein the unskipped CG occasion is associated with a component carrier of a plurality of component carriers.
Aspect 29: The method of any of Aspects 25-28, wherein the skipping indication indicates the unskipped CG occasion as being skipped.
Aspect 30: An apparatus for wireless communication at a device, comprising a processor; memory coupled with the processor; and instructions stored in the memory and executable by the processor to cause the apparatus to perform the method of one or more of Aspects 1-4.
Aspect 31: A device for wireless communication, comprising a memory and one or more processors coupled to the memory, the one or more processors configured to perform the method of one or more of Aspects 1-4.
Aspect 32: An apparatus for wireless communication, comprising at least one means for performing the method of one or more of Aspects 1-4.
Aspect 33: A non-transitory computer-readable medium storing code for wireless communication, the code comprising instructions executable by a processor to perform the method of one or more of Aspects 1-4.
Aspect 34: A non-transitory computer-readable medium storing a set of instructions for wireless communication, the set of instructions comprising one or more instructions that, when executed by one or more processors of a device, cause the device to perform the method of one or more of Aspects 1-4.
Aspect 35: An apparatus for wireless communication at a device, comprising a processor; memory coupled with the processor; and instructions stored in the memory and executable by the processor to cause the apparatus to perform the method of one or more of Aspects 5-8.
Aspect 36: A device for wireless communication, comprising a memory and one or more processors coupled to the memory, the one or more processors configured to perform the method of one or more of Aspects 5-8.
Aspect 37: An apparatus for wireless communication, comprising at least one means for performing the method of one or more of Aspects 5-8.
Aspect 38: A non-transitory computer-readable medium storing code for wireless communication, the code comprising instructions executable by a processor to perform the method of one or more of Aspects 5-8.
Aspect 39: A non-transitory computer-readable medium storing a set of instructions for wireless communication, the set of instructions comprising one or more instructions that, when executed by one or more processors of a device, cause the device to perform the method of one or more of Aspects 5-8.
Aspect 40: An apparatus for wireless communication at a device, comprising a processor; memory coupled with the processor; and instructions stored in the memory and executable by the processor to cause the apparatus to perform the method of one or more of Aspects 9-13.
Aspect 41: A device for wireless communication, comprising a memory and one or more processors coupled to the memory, the one or more processors configured to perform the method of one or more of Aspects 9-13.
Aspect 42: An apparatus for wireless communication, comprising at least one means for performing the method of one or more of Aspects 9-13.
Aspect 43: A non-transitory computer-readable medium storing code for wireless communication, the code comprising instructions executable by a processor to perform the method of one or more of Aspects 9-13.
Aspect 44: A non-transitory computer-readable medium storing a set of instructions for wireless communication, the set of instructions comprising one or more instructions that, when executed by one or more processors of a device, cause the device to perform the method of one or more of Aspects 9-13.
Aspect 45: An apparatus for wireless communication at a device, comprising a processor; memory coupled with the processor; and instructions stored in the memory and executable by the processor to cause the apparatus to perform the method of one or more of Aspects 14-18.
Aspect 46: A device for wireless communication, comprising a memory and one or more processors coupled to the memory, the one or more processors configured to perform the method of one or more of Aspects 14-18.
Aspect 47: An apparatus for wireless communication, comprising at least one means for performing the method of one or more of Aspects 14-18.
Aspect 48: A non-transitory computer-readable medium storing code for wireless communication, the code comprising instructions executable by a processor to perform the method of one or more of Aspects 14-18.
Aspect 49: A non-transitory computer-readable medium storing a set of instructions for wireless communication, the set of instructions comprising one or more instructions that, when executed by one or more processors of a device, cause the device to perform the method of one or more of Aspects 14-18.
Aspect 50: An apparatus for wireless communication at a device, comprising a processor; memory coupled with the processor; and instructions stored in the memory and executable by the processor to cause the apparatus to perform the method of one or more of Aspects 19-24.
Aspect 51: A device for wireless communication, comprising a memory and one or more processors coupled to the memory, the one or more processors configured to perform the method of one or more of Aspects 19-24.
Aspect 52: An apparatus for wireless communication, comprising at least one means for performing the method of one or more of Aspects 19-24.
Aspect 53: A non-transitory computer-readable medium storing code for wireless communication, the code comprising instructions executable by a processor to perform the method of one or more of Aspects 19-24.
Aspect 54: A non-transitory computer-readable medium storing a set of instructions for wireless communication, the set of instructions comprising one or more instructions that, when executed by one or more processors of a device, cause the device to perform the method of one or more of Aspects 19-24.
Aspect 55: An apparatus for wireless communication at a device, comprising a processor; memory coupled with the processor; and instructions stored in the memory and executable by the processor to cause the apparatus to perform the method of one or more of Aspects 25-29.
Aspect 56: A device for wireless communication, comprising a memory and one or more processors coupled to the memory, the one or more processors configured to perform the method of one or more of Aspects 25-29.
Aspect 57: An apparatus for wireless communication, comprising at least one means for performing the method of one or more of Aspects 25-29.
Aspect 58: A non-transitory computer-readable medium storing code for wireless communication, the code comprising instructions executable by a processor to perform the method of one or more of Aspects 25-29.
Aspect 59: A non-transitory computer-readable medium storing a set of instructions for wireless communication, the set of instructions comprising one or more instructions that, when executed by one or more processors of a device, cause the device to perform the method of one or more of Aspects 25-29.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware, firmware, or a combination of hardware and software. As used herein, a processor is implemented in hardware, firmware, or a combination of hardware and software. As used herein, the phrase “based on” is intended to be broadly construed to mean “based at least in part on.” As used herein, “satisfying a threshold” may, depending on the context, refer to a value being greater than the threshold, greater than or equal to the threshold, less than the threshold, less than or equal to the threshold, equal to the threshold, or not equal to the threshold, among other examples. As used herein, a phrase referring to “at least one of” a list of items refers to any combination of those items, including single members. As an example, “at least one of: a, b, or c” is intended to cover: a, b, c, a+b, a+c, b+c, and a+b+c.

Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (for example, related items, unrelated items, or a combination of related and unrelated items), and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A also may have B). Further, as used herein, the term “or” is intended to be inclusive when used in a series and may be used interchangeably with “and/or,” unless explicitly stated otherwise (for example, if used in combination with “either” or “only one of”).

The various illustrative logics, logical blocks, modules, circuits and algorithm processes described in connection with the aspects disclosed herein may be implemented as electronic hardware, computer software, or combinations of both. The interchangeability of hardware and software has been described generally, in terms of functionality, and illustrated in the various illustrative components, blocks, modules, circuits and processes described herein. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single-or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Aspects of the subject matter described in this specification also can be implemented as one or more computer programs (such as one or more modules of computer program instructions) encoded on a computer storage media for execution by, or to control the operation of, a data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the media described herein should also be included within the scope of computer-readable media. Additionally, the operations of a method or algorithm may reside as one or any combination or set of codes and instructions on a machine readable medium and computer-readable medium, which may be incorporated into a computer program product.

Various modifications to the aspects described in this disclosure may be readily apparent to those skilled in the art, and the generic principles defined herein may be applied to other aspects without departing from the spirit or scope of this disclosure. Thus, the claims are not intended to be limited to the aspects shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate aspects also can be implemented in combination in a single aspect. Conversely, various features that are described in the context of a single aspect also can be implemented in multiple aspects separately or in any suitable subcombination. Moreover, although features may be described as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the aspects described should not be understood as requiring such separation in all aspects, and it should be understood that the described program components and systems can generally be integrated together in a single software product or packaged into multiple software products. Additionally, other aspects are within the scope of the following claims. In some cases, the actions recited in the claims can be performed in a different order and still achieve desirable results.

What is claimed is:

1. A method of wireless communication performed by a user equipment (UE), comprising:
transmitting, in a first physical uplink shared channel (PUSCH) occasion, a first PUSCH communication including an indication associated with at least one skipped configured grant (CG) occasion;
receiving a scheduling communication that indicates a second PUSCH occasion for a re-transmission of the first PUSCH communication; and
transmitting, in the second PUSCH occasion, a second PUSCH communication, the second PUSCH communication including a re-transmission of the first PUSCH communication and the indication associated with the at least one skipped CG occasion.

2. The method of claim 1, wherein an application time associated with a first skipped CG occasion of the at least one skipped CG occasion comprises a start time associated with the transmission of the first PUSCH communication.

3. The method of claim 1, wherein at least one of the first PUSCH occasion or the second PUSCH occasion comprises a CG PUSCH occasion.

4. The method of claim 1, wherein at least one of the first PUSCH occasion or the second PUSCH occasion comprises a dynamic grant PUSCH occasion.

5. A method of wireless communication performed by a network node, comprising:
receiving, in a first physical uplink shared channel (PUSCH) occasion, a first PUSCH communication including an indication associated with at least one skipped configured grant (CG) occasion;
transmitting a scheduling communication that indicates a second PUSCH occasion for a re-transmission of the first PUSCH communication; and
receiving, in the second PUSCH occasion, a second PUSCH communication, the second PUSCH communication including a re-transmission of the first PUSCH communication and the indication associated with the at least one skipped CG occasion.

6. The method of claim 5, wherein an application time associated with a first skipped CG occasion of the at least one skipped CG occasion comprises a start time associated with the transmission of the first PUSCH communication.

7. The method of claim 5, wherein at least one of the first PUSCH occasion or the second PUSCH occasion comprises a CG PUSCH occasion.

8. The method of claim 5, wherein at least one of the first PUSCH occasion or the second PUSCH occasion comprises a dynamic grant PUSCH occasion.

9. A method of wireless communication performed by a user equipment (UE), comprising:
transmitting, in a physical uplink shared channel (PUSCH) occasion, a PUSCH communication including an indication associated with at least one skipped configured grant (CG) occasion; and
receiving a confirmation communication that indicates reception, by a network node, of the indication associated with the at least one skipped CG occasion.

10. The method of claim 9, wherein the confirmation communication comprises downlink control information.

11. The method of claim 9, wherein the confirmation communication comprises a downlink medium access control control element.

12. The method of claim 9, wherein an application time associated with a first skipped CG occasion of the at least one skipped CG occasion comprises a start time associated with the transmission of the PUSCH communication.

13. The method of claim 9, wherein an application time associated with a first skipped CG occasion of the at least one skipped CG occasion comprises a start time associated with the reception of the confirmation communication.

14. A method of wireless communication performed by a user equipment (UE), comprising:
transmitting, in a physical uplink shared channel (PUSCH) occasion, a first PUSCH communication including an indication associated with at least one skipped configured grant (CG) occasion; and
transmitting, in an unskipped CG occasion of the at least one CG occasion, an uplink communication including uplink control information (UCI) multiplexed with a second PUSCH communication.

15. The method of claim 14, wherein the unskipped CG occasion is associated with a CG configuration that is configured as unskippable.

16. The method of claim 14, wherein the unskipped CG occasion is associated with a CG configuration that is configured as skippable.

17. The method of claim 14, wherein the unskipped CG occasion is associated with a component carrier of a plurality of component carriers.

18. The method of claim 14, further comprising refraining from multiplexing UCI in any CG occasion, of the at least one CG occasion, that is configured as skippable.

19. The method of claim 14, wherein the indication indicates the unskipped CG occasion as being skipped.
